(19) United States
(12) Patent Application Publication
(10) Pub. No.: US 2021/0374812 A1
(43) Pub. Date: Dec. 2, 2021

(54) METHODS AND SYSTEMS FOR TRAINING AND LEVERAGING DONOR PREDICTION MODELS

(71) Applicant: BOODLE, INC., McLean, VA (US)

(72) Inventors: Francis Quang Hoang, Alexandria, VA (US); Shawn Nathan Olds, Falls Church, VA (US); Yang-pin Ansel Teng, Tustin, CA (US); Matthew Dale Hicks, Norman, OK (US); Eric James Okimoto, Windermere, FL (US); Thomas Frederick Davids, West Lebanon, NH (US)

(73) Assignee: BOODLE, INC., McLean, VA (US)

(21) Appl. No.: 17/343,168

(22) Filed: Jun. 9, 2021

Related U.S. Application Data
(63) Continuation of application No. PCT/US2019/065329, filed on Dec. 10, 2019.
(60) Provisional application No. 62/777,341, filed on Dec. 10, 2018.

(51) Int. Cl. G06Q 30/02; G06N 20/00; G06N 5/04

(52) U.S. Cl. CPC G06Q 30/0279; G06N 5/04; G06N 20/00

(57) ABSTRACT

The present disclosure relates to a campaign management platform that manages campaigns on behalf of an organization. In embodiments, a method includes receiving organizational data from the organization that indicates donor outcome data and attributes of previous donors to previous campaigns of the organization. The method includes determining random individual data of a plurality of random individuals including attributes thereof. The method also includes generating training data based on the donor outcome data and the random individual data and training a machine-learned donor prediction model based on the training data that is trained to receive a set of attributes of an individual and determine a likelihood that the individual will donate to the campaign based on the set of attributes of the individual, where the donor prediction model may be leveraged to determine whether a lead of the campaign is likely to contribute to a campaign of the organization.

### CROSS-REFERENCE TO RELATED APPLICATIONS

This application is a bypass continuation of International Application No. PCT/US2019/065329, filed on Dec. 10, 2019, which claims the benefit of priority to U.S. Provisional Patent Application No. 62/777,341 entitled “SYSTEMS AND METHODS FOR INTELLIGENT PEER-TO-PEER FUNDRAISING CAMPAIGN MANAGEMENT” filed on Dec. 10, 2018. Each of the above applications are incorporated herein by reference in their entirety.

### TECHNICAL FIELD

This application relates to a computing and networking architecture for handling fundraising campaigns. More particularly, this application relates to systems and methods for an intelligent fundraising platform, including artificial intelligence for creating and managing fundraising campaigns, identifying potential donors, automated generation of personalized messaging to the potential donors, and/or predicting likelihood of donation by potential donors.

### BACKGROUND

Non-profit organizations rely on philanthropic donations for financial support, but most organizations face significant challenges in fundraising as they undertake various campaigns, such as for general support (e.g., annual giving campaigns) or support for particular capital investments, projects, and/or activities. One difficult challenge for fundraising campaigns is finding new donors in a cost-effective manner. In fact, the cost of acquisition of a new donor in a fundraising campaign often exceeds the amount donated by the donor to the campaign. A need exists for more efficient and effective systems for finding and engaging donors to fundraising campaigns.

Many non-profit organizations, such as educational institutions, museums, libraries, political organizations, service organizations, non-governmental organizations, and many others, are supported by individuals, such as alumni, who have a degree of affinity for the organizations. While some individuals participate formally in organizations (such as by membership), attend events, and the like, many others do not. A need exists for systems that find, attract, and engage a wider set of individuals who feel a degree of affinity for an organization.

In some cases, an individual may have a modest degree of affinity for an organization while having a much higher affinity for a particular project or activity, such as a project or activity involving a topic of interest, a social cause, a valued individual or group of people, or the like. A need exists for systems that find, attract and engage individuals who are willing and excited to provide philanthropic support to a campaign for a project or activity of an organization.

Similar challenges exist for other campaigns, including marketing campaigns, political campaigns, fundraising campaigns (such as for companies seeking investors) and recruiting campaigns, and a need exists for systems that enable supporters to attract and engage support for such other campaigns.

### SUMMARY

According to some embodiments of the present disclosure, a method for managing a peer-to-peer campaign is disclosed. In embodiments, the method includes determining, by one or more processors of a computing system, supporter attributes of a supporter of the campaign. The method further includes generating, by the one or more processors, a supporter profile corresponding to the supporter based on the supporter attributes. The method also includes determining, by the one or more processors, campaign attributes of the campaign. The method further includes determining, by the one or more processors, a set of leads, each lead corresponding to a respective unique identifier of the lead. The method also includes, for each lead: determining, by the one or more processors, a set of lead attributes of the lead based on the unique identifier of the lead; determining, by the one or more processors, whether the lead is likely to donate to the campaign based on the set of lead attributes and a donor prediction model that is trained to determine a confidence score that indicates a likelihood that a person will donate to the campaign given a set of attributes of the person; an in response to determining that the lead is likely to donate to the campaign, initiating, by the one or more processors, solicitation of a contribution to the campaign from the lead by the supporter based on at least two of the supporter attributes, the campaign attributes, and the lead attributes of the lead.

In embodiments, the campaign is a charitable fundraising campaign. In some of these embodiments, the fundraising campaign is selected from a list of charitable projects including translation projects, clean water projects, education projects, building projects, missionary projects, disaster relief projects, restoration projects, and acquisition projects.

In embodiments, the campaign is a political campaign.

In embodiments, the set of sponsor attributes include one or more of personally identifiable information, social network information, contacts of the sponsor, financial information relating to the sponsor, education of the sponsor, and information about current and past organizations attended and/or supported by the sponsor.

In embodiments, campaign attributes include campaign type, a cause of the campaign, content in a description of the campaign, one or more goals of the campaign, participants in the campaign, and regulatory information impacting the campaign.

In embodiments, the lead attributes are selected from an education level of the lead, a university attended by the lead, past donations by the lead, professional degrees held by the lead, a city of the lead, a state of the lead, a country of the lead, a nationality of the lead, a political affiliation of the lead, an age of the lead, an income level of the lead, a profession of the lead, and an employer of the lead.

In embodiments, the lead attributes are obtained from one or more attribute data collections. In some of these embodiments, the attribute data collections are third party data sources. In some embodiments, determining the lead attributes of the lead includes: querying a first third-party data source using a unique identifier associated with the lead to obtain other unique identifiers associated with the lead; and querying a second third-party data source using the unique identifier and the other unique identifiers associated with the lead to determine the lead attributes. In some embodiments, the unique identifier of the lead is an email address or a mobile phone number of the lead. In some embodiments, determining the lead attributes further includes querying the second third-party data source using a combination of semi-unique identifiers of the lead. In embodiments, determining the lead attributes of the lead further includes: querying a third third-party data source with the unique identifier associated with the lead and the other unique identifiers associated with the lead to obtain a second set of lead attributes of the individual; and combining the second set of lead attributes with the lead attributes obtained from the second third-party data source.

In embodiments, the supporter is solicited by the campaign and is otherwise unaffiliated with the campaign.

In embodiments, the machine-learned donor prediction model is trained specifically for the campaign. In some of these embodiments, the machine-learned donor prediction model is trained using only organizational data of the organization and platform data that is determined by the computing system, wherein the organizational data of the organization is restricted from being used to train donor prediction models on behalf of other organizations. In embodiments, the organizational data includes donor outcome data provided by the organization.

In embodiments, determining the set of leads includes obtaining a set of contacts of the supporter.

In embodiments, determining the set of leads includes identifying a set of individuals that correspond to the supporter based on one or more of the supporter attributes.

In embodiments, determining the set of leads includes identifying a set of individuals that correspond to the campaign based on one or more of the campaign attributes and a set of individual attributes of each respective individual.

According to some embodiments of the present disclosure, a computer-implemented method for enlisting donors to a campaign is disclosed. The method includes determining, by one or more processors of a computing system, a set of leads, wherein each lead is associated with a respective unique identifier. For each respective lead in the set of leads, the method includes: querying, by the one or more processors, a first attribute data collection with a unique identifier of the respective lead to obtain a first set of attributes of the respective lead; querying, by the one or more processors, a second attribute data collection with the unique identifier of the lead to obtain any other unique identifiers associated with the lead; querying, by the one or more processors, the first attribute data collection with the one or more other unique identifiers to obtain a second set of attributes of the respective lead; generating, by the one or more processors, a lead profile of the respective lead based on the first set of attributes and the second set of attributes; determining, by the one or more processors, whether the respective lead is likely to donate to the campaign based on the lead profile and a machine-learned donor prediction model; and in response to determining that the lead is likely to donate to the campaign, initiating, by the one or more processors, a solicitation of a donation from the respective lead.

In embodiments, the first attribute data collection is stored in memory of the computing system and the second attribute data collection is queried via an API of a third-party data provider.

In embodiments, the first unique identifier is an email address of the lead.

In embodiments, the other unique identifiers are alternative email addresses of the lead.

In embodiments, the first unique identifier is a mobile phone number of the lead.

In embodiments, the method further includes for each lead, querying, by the one or more processors, the second attribute data collection with two or more non-unique attributes of the lead to determine additional unique identifiers associated with the lead. In these embodiments, the method further includes in response to determining that the respective lead is associated with one or more other unique identifiers, querying, by the one or more processors, the first attribute data collection with the one or more additional unique identifiers to obtain the second set of attributes of the respective lead. In some of these embodiments, the two or more non-unique attributes of the lead include a name of the lead and an employer of the lead. In embodiments, the two or more non-unique attributes include of the lead include a name of the lead, a city of the lead, and an age of the lead. In embodiments, the two or more non-unique attributes include of the lead include a name of the lead, a city of the lead, a state of the lead, and an age of the lead. In embodiments, the two or more non-unique attributes of the lead are obtained from the historical donor data. In embodiments, the method further includes querying, by the one or more processors, a third attribute data collection with the unique identifier and the one or more additional unique identifiers of the respective lead to obtain a third set of attributes of the respective lead, wherein the lead profile is further based on the third set of attributes of the respective lead.

In embodiments, the machine-learned donor prediction model is trained in part using historical donor data of an organization affiliated with the campaign that indicates attributes of past donors to campaigns of the organization. In embodiments, the machine-learned donor prediction model is trained specifically for the campaign.

In embodiments, the historical donor data of the organization is used only in association with the organization.

In embodiments, determining the set of leads includes receiving a contact list of a supporter of the campaign, the contact list including a set of contacts and for each contact, at least one unique identifier of the contact, wherein each contact is a respective lead.

In embodiments, determining the set of leads includes identifying a set of individuals that correspond to the campaign based on one or more campaign attributes of the campaign and a set of individual attributes of each respective individual.

In embodiments, the campaign is a fundraising campaign.

According to some embodiments of the present disclosure, a method for managing online campaigns is disclosed. The method includes creating, by one or more processors of a computing system, a campaign on behalf of an organization and receiving, by the one or more processors, historical donor data from the organization, the historical donor data indicating a plurality of donors that have contributed to the organization in the past and, for each donor of the plurality of donors, a respective set of donor attributes of the donor. The method includes determining, by the one or more processors, random individual data of a plurality of random individuals, the random individual data indicating respective sets of individual attributes for a plurality of random individuals. The method further includes generating, by the one or more processors, training data based on the historical donor data and the random individual data. The method also includes training, by the one or more processors, a donor prediction model based on the training data, wherein the donor prediction model is trained to receive a set of attributes of an individual and determine a likelihood that the individual will donate to the campaign. The method also includes leveraging, by the one or more processors, the donor prediction module to determine whether a lead of the campaign is likely to contribute to the campaign based on one or more lead attributes of the lead donor.

In embodiments, generating the training data includes: obtaining additional donor attributes from one or more alternative data sources, the additional attributes including attribute types not initially included in the donor data; and supplementing the donor data with the additional donor attributes to obtain supplemented donor data. In some embodiments, the supplemental donor data and the random person data define the same types of attributes. Furthermore, in some embodiments, obtaining the additional donor attributes includes, for each donor in the list of donors: querying a first alternative data source using a unique identifier associated with the donor to obtain other unique identifiers associated with the donor; and querying a second alternative data source using the unique identifier and the other unique identifiers associated with the lead to determine the donor attributes. In some of these embodiments, the unique identifier of a donor is an email address of the donor.

In embodiments, the machine-learned donor prediction model is a look-alike model.

In embodiments, the look-alike model is a random forest model that includes a plurality of decision trees.

In embodiments, the random individual data of each random individual includes a set of random individual attributes and a negative donation outcome that is assigned to the random individual. In some of these embodiments, the random individual attributes of the random individual are obtained from a third-party data source that provides attributes of a collection of different individuals. In embodiments, determining the random individual data of the plurality of random individuals includes determining a number of random individuals to include in the plurality of random individuals based on a number of past donors in the plurality of donors indicated in the historical donor data of the organization. In embodiments, the number of random individuals is set such that a ratio of the number of random individuals to the number of past donors is equal to a predetermined ratio.

In embodiments, the machine-learned donor prediction model is trained specifically for the campaign. In some of these embodiments, the historical donor data of the organization is used only in association with the organization.

In embodiments, the campaign is a charitable fundraising campaign.

According to some embodiments of the present disclosure, a method for automating a campaign on behalf of an organization is disclosed. The method includes determining, by one or more processors of a computing system, a set of leads, each lead having a unique identifier associated therewith. The method further includes, for each lead in the set of leads: generating, by the one or more processors, a lead profile based on the unique identifier of the lead, the lead profile indicating a set of lead attributes of the lead; determining, by the one or more processors, whether the lead is likely to donate to the campaign based on the lead profile of the lead and a donor prediction model that is trained to receive one or more individual attributes of an individual and output a prediction indicating a likelihood that the individual will donate to the campaign of the organization based on the individual attributes of the individual. Furthermore, for each lead, the method includes, in response to determining that the lead is likely to donate to the fundraising campaign: generating, by the one or more processors, machine-generated text based on the campaign attributes of the campaign, the lead attributes of the lead, and one or more text generation templates; and initiating, by the one or more processors, solicitation of a donation to the fundraising campaign based on the machine-generated text.

In embodiments, generating the machine-generated text includes generating a message subject line using a subject line text generation template, the lead attributes of the lead, and the campaign attributes.

In embodiments, generating the machine-generated text includes generating message body text using a message body text generation template, the lead attributes of the lead, and the campaign attributes.

In embodiments, generating the machine-generated text includes identifying one or more lead attributes of the lead that correlate with one or more campaign attributes of the campaign. In some of these embodiments, generating the machine-generated text further includes generating the machine-generated text based on a text generation template of the one or more text generation templates, the one or more lead attributes of the lead, and the one or more campaign attributes that correlate to the one or more lead attributes. In some embodiments, the text generation template is selected from a set of text generation templates based on the one or more campaign attributes and the one or more lead attributes. In some embodiments, generating the machine-generated text includes inputting the selected text generation template, the one or more campaign attributes, and the one or more lead attributes into a natural processing system.

In embodiments, the method further includes generating, by the one or more processors, the donor prediction model based in part on historical donor data from the organization, wherein the donor data indicates a list of past donors to the organization. In some of these embodiments, determining whether the lead is likely to donate to the fundraising campaign includes: generating a feature vector corresponding to the lead based on the set of attributes in the lead profile; inputting the feature vector into the donor prediction model to obtain a confidence score that indicates a likelihood that the lead donates to the fundraising campaign; and determining whether the lead is likely to donate to the fundraising campaign based on the confidence score.

In embodiments, the machine-learned donor prediction model is trained specifically for the campaign. In some of these embodiments, the historical donor data of the organization is used only in association with the organization.

In embodiments, determining the set of leads includes receiving a contact list of a supporter of the campaign, the contact list including a set of contacts and for each contact, at least one unique identifier of the contact, wherein each contact is a respective lead.

In embodiments, determining the set of leads includes identifying a set of individuals that correspond to the campaign based on one or more campaign attributes of the campaign and a set of individual attributes of each respective individual.

In embodiments, the method further includes: monitoring, by the one or more processors, an outcome relating to a message containing the machine-generated text; and updating, by the one or more processors, a text generation template of the one or more text generation templates based on feedback relating to the text generation template that includes the outcome.

In embodiments, the method further includes: selecting, by the one or more processors, a messaging medium to use to solicit the donation from the lead based on the lead attributes of the lead; generating, by the one or more processors, a personalized message using the machine-generated text; and transmitting, by the one or more processors, the personalized message via the selected messaging medium.

In embodiments, the one or more text generation template are selected based on a relationship between the lead attributes of the lead and the campaign attributes.

In embodiments, the one or more text generation templates are selected to adhere to a certain level of formality.

In embodiments, the one or more text generation templates are selected to adhere to a certain mood.

According to some embodiments of the present disclosure, a method for managing an online campaign is disclosed. The method includes creating, by one or more processors of a computing system, a campaign on behalf of an organization, the campaign having a set of campaign attributes and training, by the one or more processors, a donor prediction model based in part on historical donor data from the organization, wherein the historical donor data indicates a list of previous donors to the organization, and the donor prediction model is trained to receive individual attributes of an individual and output a prediction indicating a likelihood that the individual will donate to the campaign of the organization based on the individual attributes of the individual. The method further includes determining, by the one or more processors, a set of leads, each lead including a unique identifier of the lead. The method also includes, for each lead in the set of leads: generating, by the one or more processors, a lead profile based on the unique identifier of the lead, the lead profile indicating a set of lead attributes of the lead; determining, by the one or more processors, whether the lead is likely to donate to the campaign based on the lead profile of the lead and the donor prediction model. Furthermore, in response to determining that the lead is likely to donate to the campaign, the method includes determining, by the one or more processors, solicitation information based on the set of campaign attributes and the set of lead attributes of the lead, wherein the solicitation information includes a prompt and/or a recommendation for soliciting a contribution from the lead; and initiating, by the one or more processors, solicitation of a donation to the campaign based on the solicitation information.

In embodiments, initiating solicitation of a donation includes outputting the solicitation information to a supporter of the campaign that is soliciting the donation from the lead.

In embodiments, initiating solicitation of a donation includes generating machine-generated text based on the solicitation information and a text generation template, wherein the machine-generated text is included in an electronic communication that is sent to the lead.

In embodiments, determining the solicitation information includes determining a relationship between the lead and the campaign by identifying one or more lead attributes of the lead that are correlated to one or more campaign attributes of the campaign. In some embodiments, determining the relationship between the lead and the campaign includes identifying that the lead attended a respective university and that the campaign is raising funds for the university. In some embodiments, determining the relationship between the lead and the campaign includes identifying that the lead has an income level above an upper threshold and that the campaign is seeking contributions from high net worth individuals. In some embodiments, determining the relationship between the lead and the campaign includes identifying that the lead is registered to a political party and that the campaign is seeking contributions to support the political party. In some embodiments, determining the relationship between the lead and the campaign includes identifying that the lead is registered to a political party and resides in a particular voting district and that the campaign is seeking contributions to support a candidate of the political party running for office in the particular voting district. In some embodiments, determining the relationship between the lead and the campaign includes identifying that the lead has a pet and that the campaign is seeking contributions to support an animal welfare charity. In some embodiments, determining the relationship between the lead and the campaign includes identifying that the lead has a professional degree and that the campaign is seeking contributions to support a professional association having members that have the professional degree. In some embodiments, the relationship between the lead and the campaign is determined probabilistically.

In embodiments, determining the set of leads includes receiving a contact list of a supporter of the campaign, the contact list including a set of contacts and for each contact, at least one unique identifier of the contact, wherein each contact is a respective lead.

In embodiments, determining the set of leads includes identifying a set of individuals that correspond to the campaign based on one or more campaign attributes of the campaign and a set of individual attributes of each respective individual.

According to some embodiments of the present disclosure, a method for automating campaigns is disclosed. The method includes creating, by one or more processors of a computing system, a campaign on behalf of an organization, the campaign having a set of campaign attributes and generating, by the one or more processors, a donor prediction model based in part on historical donor data from the organization. The historical donor data indicates a list of previous donors to the organization, and the donor prediction model is trained to receive individual attributes of an individual and output a prediction indicating a likelihood that the individual will donate to the campaign of the organization based on the individual attributes of the individual. The method further includes determining, by the one or more processors, a set of leads, each lead being associated with a unique identifier. The method also includes, for each lead in the set of leads, generating, by the one or more processors, a lead profile based on the unique identifier of the lead, the lead profile indicating a set of lead attributes of the lead and determining, by the one or more processors, whether the lead is likely to donate to the campaign based on the lead profile of the lead and the donor prediction model. Furthermore, in response to determining that the lead is likely to donate to the campaign, the method includes: initiating, by the one or more processors, solicitation of a contribution to the campaign from the lead; collecting, by the one or more processors, outcome data from one or more feedback sources, the outcome data corresponding to the solicitation of the contribution and indicating whether the solicitation resulted in a positive outcome or a negative outcome; and reinforcing, by the one or more processors, the donor prediction model based on the outcome data and one or more solicitation attributes of the solicitation.

In embodiments, collecting outcome data from one or more feedback sources includes transmitting an electronic message to the lead and determining whether the lead opens the electronic message. In some embodiments, in response to the lead opening the electronic message, the donor prediction model is reinforced with a training data set that indicates the lead attributes of the lead and a positive outcome that indicates that the electronic message was opened by the lead. In some embodiments, the training data set further includes the subject line of the electronic communication.

In some embodiments, collecting outcome data from one or more feedback sources includes transmitting an electronic message to the lead and determining whether the lead clicks a link the electronic message. In some embodiments, in response to the lead clicking the link the electronic message, the donor prediction model is reinforced with a training data set that indicates the lead attributes of the lead and a positive outcome that indicates that the link in the electronic message was clicked by the lead.

In some embodiments, collecting outcome data from one or more feedback sources includes transmitting an electronic message to the lead and determining whether the lead donated to the fundraising campaign. In some embodiments, in response to the lead donating to the fundraising campaign, the donor prediction model is reinforced with a training data set that indicates the lead attributes of the lead and a positive outcome that indicates that the lead donated to the fundraising campaign. In some embodiments, the training data set further includes an amount donated by the lead.

In embodiments, the machine-learned donor prediction model is trained specifically for the campaign. In some embodiments, the historical donor data of the organization is used only in association with the organization.

In embodiments, determining the set of leads includes receiving a contact list of a supporter of the campaign, the contact list including a set of contacts and for each contact, at least one unique identifier of the contact, wherein each contact is a respective lead.

In embodiments, determining the set of leads includes identifying a set of individuals that correspond to the campaign based on one or more campaign attributes of the campaign and a set of individual attributes of each respective individual.

According to some embodiments of the present disclosure, a method for managing online campaigns is disclosed. The method includes generating, by one or more processors of a computing system, a campaign on behalf of an organization, the campaign having a set of campaign attributes that are selected from: a campaign type, a cause of the campaign, content in a description of the campaign, one or more goals of the campaign, participants in the campaign, and regulatory information impacting the campaign. The method also includes receiving, by the one or more processors, historical donor data from the organization, the historical donor data indicating a plurality of donors that have contributed to the organization in the past and, for each donor of the plurality of donors, a respective set of donor attributes of the donor. The method also includes generating, by the one or more processors, a plurality of training data sets based on the historical donor data, wherein each training data set includes a set of individual attributes of a respective individual and an outcome corresponding to the respective individual, wherein the individual attributes are selected from: an education level of the respective individual, a university attended by the respective individual, past donations by the respective individual, professional degrees held by the respective individual, a city of the respective individual, a state of the respective individual, a country of the respective individual, a nationality of the respective individual, a political affiliation of the respective individual, an age of the respective individual, an income level of the respective individual, a profession of the respective individual, and an employer of the respective individual. The method further includes training, by the one or more processors, a donor prediction model based on the training data, wherein the donor prediction model is trained to receive a set of person attributes of a person and determine a likelihood that the person is likely to donate to the fundraising campaign based on the person attributes of the person. The method also includes identifying, by the one or more processors, a lead for the campaign based on the campaign attributes and a set of lead attributes of the lead, wherein the set of lead attributes are selected from: an education level of the lead, a university attended by the lead, past donations by the lead, professional degrees held by the lead, a city of the lead, a state of the lead, a country of the lead, a nationality of the lead, a political affiliation of the lead, an age of the lead, an income level of the lead, a profession of the lead, and an employer of the lead. The method also includes leveraging, by the one or more processors, the donor prediction model to determine whether the lead is likely to contribute to the campaign based on one or more lead attributes of the lead. Furthermore, in response to determining that the lead is likely to contribute to the campaign, the method includes initiating, by the one or more processors, a solicitation of a contribution to the campaign.

In embodiments, the campaign attributes are provided by a user affiliated with the organization.

In embodiments, contact attribute types are selected based on the campaign attributes.

In embodiments, generating a training data set of the plurality of training data includes: identifying a donation event in the historical donor data; determining a set of donor attributes of a donor corresponding to the donation event from the historical donor data; obtaining additional donor attributes of the donor from one or more alternative data sources; and enriching the set of donor attributes with the additional donor attributes.

In embodiments, generating a training data set of the plurality of training data sets includes: obtaining random individual attributes of a random individual from an alternative data source, wherein the random individual is unrelated to the campaign; and generating the training data set based on the random individual attributes, wherein the training data set is assigned a negative donation outcome.

In embodiments, in response to initiating the solicitation of a contribution from the lead, the method further includes: collecting, by the one or more processors, outcome data from one or more feedback sources, the outcome data indicating whether the solicitation of the lead resulted in a positive outcome or a negative outcome; and reinforcing, by the one or more processors, the donor prediction model based on the outcome data and one or more lead attributes of the lead.

In embodiments, the method further includes, in response to determining that the lead is likely to donate to the fundraising campaign: determining, by the one or more processors, solicitation information based on the set of campaign attributes and the set of lead attributes of the lead, wherein the solicitation information includes a prompt and/or a recommendation for soliciting a contribution from the lead; and initiating, by the one or more processors, solicitation of a donation to the fundraising campaign based on the solicitation information.

In embodiments, the method further includes, in response to determining that the lead is likely to donate to the fundraising campaign: generating, by the one or more processors, machine-generated text based on the campaign attributes of the fundraising campaign, the lead attributes of the lead, and one or more text generation templates; and initiating, by the one or more processors, solicitation of a donation to the fundraising campaign based on the machine-generated text.

In embodiments, the method further includes, in response to determining that the lead is likely to donate to the fundraising campaign, initiating, by the one or more processors, solicitation of a donation from the lead to the fundraising campaign.

In embodiments, the machine-learned donor prediction model is trained specifically for the campaign. In some embodiments, the historical donor data of the organization is used only in association with the organization.

In embodiments, identifying the lead includes receiving a contact list of a supporter of the campaign, the contact list including a set of contacts and for each contact, at least one unique identifier of the contact, wherein the lead is one of the contacts in the set of contacts.

In embodiments, identifying the lead includes identifying an individual having one or more individual attributes that correspond to one or more of the campaign attributes of the campaign.

According to some embodiments of the present disclosure, a method automating an online campaign on behalf of an organization is disclosed. The method includes identifying, by one or more processors of a computing system, a lead for the campaign, the lead having a unique identifier associated therewith and determining, by the one or more processors, a set of lead attributes of the lead from one or more attribute collections. The method also includes generating, by the one or more processors, a lead profile corresponding to the set of lead attributes and determining, by the one or more processors, whether the lead is likely to donate to the campaign based on the lead profile and a donor prediction model that is trained to receive one or more individual attributes of an individual and output a prediction indicating a likelihood that the individual will donate to the campaign of the organization based on the individual attributes of the individual. The method further includes, in response to determining that the lead is likely to donate to the fundraising campaign: determining, by the one or more processors, a giving propensity of the lead, the giving propensity indicating of a monetary amount that the lead is likely to donate given the set of lead attributes of the lead; generating, by the one or more processors, machine-generated text based on a set of campaign attributes of the campaign, the set of lead attributes of the lead, the giving propensity of the lead, and one or more text generation templates; and initiating, by the one or more processors, solicitation of a donation to the fundraising campaign based on the machine-generated text.

In embodiments, generating the machine-generated text includes generating a gift string that is included in a message body based on the giving propensity of the lead.

In embodiments, generating the machine-generated text includes generating a message subject line using a subject line text generation template, the lead attributes of the lead, and the campaign attributes.

In embodiments, generating the machine-generated text includes generating message body text using a message body text generation template, the lead attributes of the lead, and the campaign attributes.

In embodiments, generating the machine-generated text includes identifying one or more lead attributes of the lead that correlate with one or more campaign attributes of the campaign. In some embodiments, generating the machine-generated text further includes generating the machine-generated text based on a text generation template, the one or more lead attributes of the lead, and the one or more campaign attributes that correlate to the one or more lead attributes. In some embodiments, the text generation template is selected from a set of text generation templates based on the one or more campaign attributes and the one or more lead attributes.

In embodiments, the method further includes training, by the one or more processors, the donor prediction model based in part on historical donor data from the organization, wherein the historical donor data indicates a list of past donors to the organization and one or more attributes of each donor. In some embodiments, the machine-learned donor prediction model is trained specifically for the campaign. In some embodiments, the historical donor data of the organization is used only in association with the organization.

In embodiments, determining whether the lead is likely to donate to the fundraising campaign includes: generating a feature vector corresponding to the lead based on the set of lead attributes in the lead profile; inputting the feature vector into the donor prediction model to obtain a confidence score that indicates a likelihood that the lead donates to the fundraising campaign; and determining whether the lead is likely to donate to the fundraising campaign based on the confidence score.

In embodiments, determining a giving propensity of the lead includes: inputting a subset of lead attributes from the lead profile into a giving propensity prediction model that is trained on previous donation amounts of past donors to the campaign and respective sets of donor attributes of the past donors, wherein the giving propensity prediction model outputs the giving propensity of the lead based on the subset of lead attributes. In some embodiments, the giving propensity prediction model is further trained on campaign attributes of the campaign. In some embodiments, the giving propensity prediction model is trained to predict when a potential donor is likely a high value donor.

In embodiments, identifying the lead includes receiving a contact list of a supporter of the campaign, the contact list including a set of contacts and for each contact, at least one unique identifier of the contact, wherein the lead is one of the contacts in the set of contacts.

In embodiments, identifying the lead includes identifying an individual having one or more individual attributes that correspond to one or more of the campaign attributes of the campaign.

According to some embodiments of the present disclosure, a method managing an online campaign on behalf of an organization is disclosed. The method includes receiving, by a processing device, a contact list indicating respective contact information of each individual in a set of individuals and generating, by the processing device, a lead profile for a lead from the set of individuals based on the contact information of the lead and one or more third party data sources, wherein the lead profile indicates a set of individual attributes of the lead. The method also includes determining, by the processing device, whether the lead is likely to contribute to a campaign based on the lead profile and a machine-learned prediction model that is trained to predict a likelihood that a person contributes to the campaign given a respective set of attributes of the person and, in response to determining that the lead is likely to donate to the campaign, initiating, by the one or more processors, solicitation of a contribution to the campaign from the lead.

In embodiments, generating the lead profile for the individual includes obtaining a subset of the individual attributes of the lead from the one or more third party data sources using the contact information of the lead. In some embodiments, obtaining the subset of the individual attributes of the lead includes querying, by the one or more processors, a first third party data source with a unique identifier of the lead to obtain a first set of individual attributes of the lead; querying, by the one or more processors, a second third party data source with the unique identifier of the lead to obtain other unique identifiers associated with the lead; querying, by the one or more processors, the first attribute data collection with the one or more other unique identifiers to obtain a second set of attributes of the respective lead; and combining, by the one or more processors, the first set of individual attributes and the second set of individual attributes to obtain the subset of the individual attributes. In some embodiments, the unique identifier of the lead is an email address or a mobile phone number of the lead. In some embodiments, obtaining the subset of the individual attributes of the lead includes further includes: probabilistically determining a set of semi-unique identifiers corresponding to the lead based on the first set of individual attributes and querying the first third-party data source using a combination of semi-unique identifiers to obtain the second set of individual attributes.

In embodiments, the contact list is received from a supporter of the campaign. In some embodiments, initiating solicitation of a contribution includes: determining solicitation information based on a relationship between the supporter and the lead based on the set of individual attributes of the lead and a set of supporter attributes of the supporter; and outputting the solicitation information to the supporter via a graphical user interface, whereby the supporter uses the solicitation information to solicit the contribution from the lead. In some embodiments, initiating solicitation of a contribution includes: determining solicitation information based on a relationship between the campaign and the lead based on the set of individual attributes of the lead and a set of campaign attributes of the campaign; and outputting the solicitation information to the supporter via a graphical user interface, whereby the supporter uses the solicitation information to solicit the contribution from the lead. In some embodiments, initiating solicitation of a contribution includes: determining solicitation information based on a relationship between the supporter and the lead based on the set of individual attributes of the lead and a set of supporter attributes of the supporter; generating personalized content for the lead based on the solicitation information; and outputting the personalized content to the supporter via a graphical user interface, whereby the supporter sends a message containing the personalized content to the lead. In some embodiments, initiating solicitation of a contribution includes: determining solicitation information based on a relationship between the campaign and the lead based on the set of individual attributes of the lead and a set of campaign attributes of the campaign; generating personalized content for the lead based on the solicitation information; and outputting the personalized content to the supporter via a graphical user interface, whereby the supporter sends a message containing the personalized content to the lead.

In embodiments, the contact list is a contact list of an organization that is organizing the campaign. In some embodiments, initiating solicitation of a contribution includes: determining solicitation information based on a relationship between the campaign and the lead based on the set of individual attributes of the lead and a set of campaign attributes of the campaign; generating personalized content for the lead based on the solicitation information; and transmitting an electronic message containing the personalized content to the lead on behalf of the organization.

In embodiments, the machine-learned donor prediction model is trained specifically for the campaign.

In embodiments, the set of individual attributes of the lead are selected from an education level of the lead, a university attended by the lead, past donations by the lead, professional degrees held by the lead, a city of the lead, a state of the lead, a country of the lead, a nationality of the lead, a political affiliation of the lead, an age of the lead, an income level of the lead, a profession of the lead, and an employer of the lead.

According to some embodiments of the present disclosure, a system for managing online campaigns is disclosed. The system includes a storage system having one or more storage mediums that store an individual datastore that stores individual records, each individual record corresponding to a respective individual and including a set of individual attributes of the individual. The system also includes a processing system having one or more processors that executes a machine learning system, a data acquisition system, an identity management system, a lead prioritization system, and an artificial intelligence system. The machine learning system trains a donor prediction models based on historical donor data from an organization that is organizing a campaign, wherein the historical donor data indicates donor outcomes from past campaigns of the organization. The data acquisition system obtains individual information from a set of different data sources, the individual information including contact information for a plurality of individuals, attribute information for the plurality of individuals. The identity management system resolves identities of the plurality of individuals to obtain an enriched set of individual attributes for each of the plurality of individuals, and for each individual of the plurality of individuals, generates an individual record for the individual based on the enriched set of individual attributes of the individual. The lead prioritization system identifies one or more leads based on lead attributes of the leads. The artificial intelligence system, for each respective of the one or more leads, determines whether the respective lead is likely to contribute to the campaign based on the lead attributes of the respective lead and the donor prediction model. In response to a determination that a lead of the one or more leads is likely to contribute to the campaign, the lead prioritization system initiates solicitation of a donation from the lead.

In embodiments, the system further includes a content generation system that determines solicitation information indicating a prompt for solicitating a contribution from the lead and identifies one or more text generation templates based on the solicitation information.

In embodiments, the system further includes natural language generation system that receives the one or more text generation templates from the content generation system and a lead identifier of the lead and generates text based on the one or more text generation templates and the lead attributes of the lead indicated by the lead identifier. In some embodiments, the content generation system determines the solicitation information based on one or more relationships between the lead and the campaign. In some embodiments, the content generation system receives determines the solicitation information based on one or more relationships between the lead and a supporter of the campaign.

In embodiments, the machine learning system generates training data based on the historical donor data and synthesized training data.

In embodiments, the synthesized training data is obtained from a third-party data source that provides individual attributes of random individuals, wherein the machine learning system generates a set of random individual profiles for a respective set of random individuals based on the individual attributes of the respective individuals and assigns a negative outcome to each random individual profile.

In embodiments, the identity management system resolves an identity of an individual based on a unique identifier of the individual. In some embodiments, the identity management system resolves the identity of the individual by: querying a first third party data source with the unique identifier of the individual to obtain a first set of individual attributes of the individual; querying a second third party data source with the unique identifier of the individual to obtain other unique identifiers associated with the individual; querying the first attribute data collection with the one or more other unique identifiers of the individual to obtain a second set of individual attributes of the individual; and combining the first set of individual attributes and the second set of individual attributes to obtain an enriched set of individual attributes of the individual. In some embodiments, the identity management system further resolves the identity of the individual by: probabilistically determining a set of semi-unique identifiers corresponding to the individual based on the first set of individual attributes and querying the first third-party data source using a combination of semi-unique identifiers to obtain the second set of individual attributes. In some embodiments, the identity management system further resolves the identity of the individual by querying a third attribute data collection with the unique identifier and the one or more other unique identifiers of the individual to obtain a third set of individual attributes of the individual and combining the third set of individual attributes with the first set of individual attributes and the second set of individual attributes to obtain the enriched set of individual attributes of the individual. In some embodiments, the unique identifier of the individual is an email address of the individual. In some embodiments, the unique identifier of the individual is a mobile phone number of the individual.

In embodiments, the data acquisition system receives the contact information of the individuals from a contact list of a supporter of the campaign.

In embodiments, the data acquisition system receives the contact information of the individuals from a contact list of the organization that is organizing the campaign.

### BRIEF DESCRIPTION OF THE FIGURES

In the accompanying figures, like reference numerals refer to identical or functionally similar elements throughout the separate views and together with the detailed description below are incorporated in and form part of the specification, serve to further illustrate various embodiments and to explain various principles and advantages all in accordance with the systems and methods disclosed herein.

FIG. 1 is a diagrammatic view that depicts a network computing environment for implementing an intelligent peer-to-peer fundraising campaign platform in accordance with the present disclosure.

FIG. 2 is a diagrammatic view that depicts methods for implementing an intelligent peer-to-peer fundraising campaign in accordance with the present disclosure.

FIG. 3 is a diagrammatic view that depicts exemplary system architecture for an intelligent peer-to-peer fundraising campaign platform in accordance with the present disclosure.

FIG. 4 is a schematic illustrating an example schema of a campaign record in accordance with the present disclosure.

FIG. 5A is a schematic illustrating an example schema of an individual record in accordance with the present disclosure.

FIG. 5B is a schematic illustrating an example individual record configured to protect organizational data in accordance with the present disclosure.

FIG. 6 is a schematic illustrating an example of a social graph storing the relationship data in accordance with the present disclosure.

FIG. 7 is a diagrammatic view that illustrates an example cognitive processes system in accordance with the present disclosure.

FIG. 8 is a diagrammatic view that depicts an example of a machine learning system training a donor prediction model in accordance with the present disclosure.

FIG. 9 is a diagrammatic view that depicts a manner by which a lead prioritization system obtains a lead list in accordance with the present disclosure.

FIG. 10 is a diagrammatic view that depicts a manner by which a lead prioritization system determines donor predictions for leads identified in the list of leads in accordance with the present disclosure.

FIG. 11 is a diagrammatic view that depicts the manner by which content generation system may generate personalized content in accordance with the present disclosure.

FIG. 12 is a flow chart depicting a method for training a donor prediction model according to some embodiments of the present disclosure.

FIG. 13 is a flow chart depicting a method for resolving the identity of an individual according to some embodiments of the present disclosure.

FIG. 14 is a flow chart depicting a method for 1400 for identifying potential contributors to a campaign of an organization according to some embodiments of the present disclosure.

FIG. 15 is a flow chart depicting a method for generating machine-generated text that is used to solicit a contribution from a potential donor according to some embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of the many embodiments of the systems and methods disclosed herein.

### DETAILED DESCRIPTION

The present disclosure will now be described in detail by describing various illustrative, non-limiting embodiments thereof with reference to the accompanying drawings and exhibits. The disclosure may, however, be embodied in many different forms and should not be construed as being limited to the illustrative embodiments set forth herein. Rather, the embodiments are provided so that this disclosure will be thorough and will fully convey the concept of the disclosure to those skilled in the art. The claims should be consulted to ascertain the true scope of the disclosure.

Before describing in detail embodiments that are in accordance with the systems and methods disclosed herein, it should be observed that the embodiments reside primarily in combinations of method and/or system components. Accordingly, the system components and method have been represented where appropriate by conventional symbols in the drawings, showing only those specific details that are pertinent to understanding the embodiments of the systems and methods disclosed herein.

All documents mentioned herein are hereby incorporated by reference in their entirety. References to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth, except where the context clearly indicates otherwise. Except where context indicates otherwise, the term “set” should be understood to include a set having one or more members.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one skilled in the art to operate satisfactorily for an intended purpose. Ranges of values and/or numeric values are provided herein as examples only and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the embodiments.

In the following description, it is understood that terms such as “first,” “second,” “third,” “above,” “below,” and the like, are words of convenience and are not to be construed as implying a chronological order or otherwise limiting any corresponding element unless expressly stated otherwise.

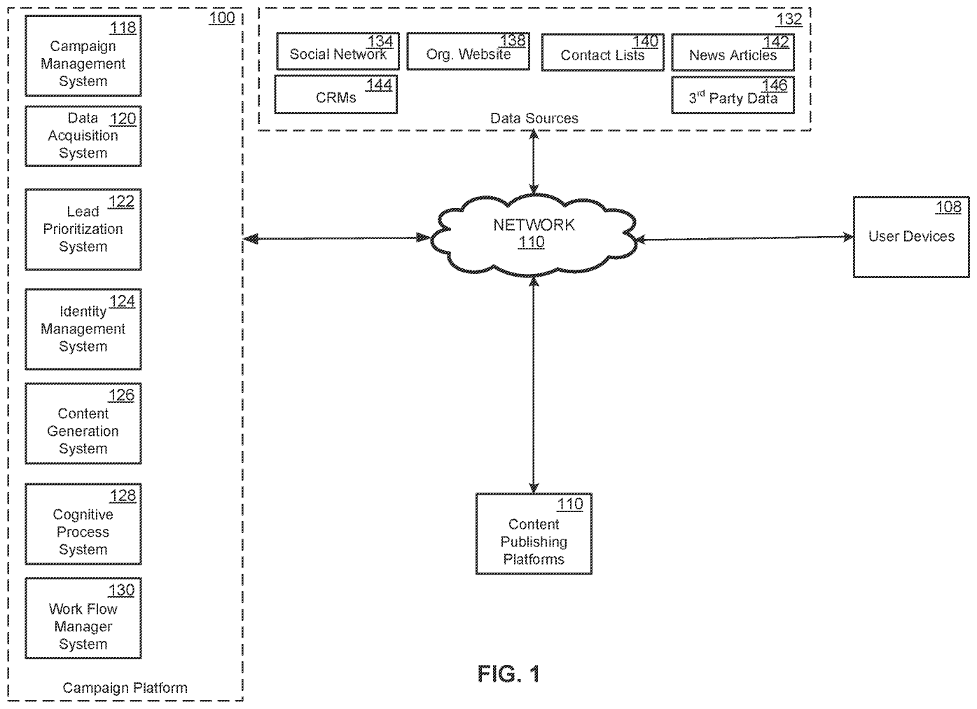

FIG. 1 provides a schematic diagram outlining the network computing environment with various information technology components, sub-components, circuits, modules, blocks, systems, sub-systems, software, methods, services, processes, and other elements for implementing one or more exemplary embodiments of the methods and systems of the current disclosure, collectively referred to in some cases herein as an intelligent campaign management the platform 100 (also referred to as “campaign the platform 100” or “the platform 100”) that supports campaigns of organizations.

In embodiments, a campaign may refer to causes where people can donate or otherwise contribute to philanthropic causes or other suitable types of causes of an organization monetarily through donations or otherwise (e.g., volunteering time, donating items, etc.). It will be understood that a campaign may encompass various types of non-profit campaigns, including (but not limited to) fundraising campaigns, recruiting campaigns, and political campaigns, except where context indicates otherwise.

In embodiments, the platform 100 is configured to identify campaign attributes and individual attributes of different types of individuals (e.g., leads, supporters, donors, and the like). The campaign attributes may include any data relevant to a campaign and/or the organization organizing the campaign. Examples of campaign attributes may include, but are not limited to, a name of the campaign, name of the organization initiating the campaign, a description of the campaign, a purpose of the campaign (e.g., building an endowment of a university, financing a building, financing a special project, and the like), keywords of the campaign, financial goals of the campaign (an amount of funds looking to be reached), nonfinancial goals of the campaign (e.g., a number of donors, a number of volunteers, etc.), types of donations being solicited (e.g., large donations, small donations, volunteers, etc.), start and/or end dates of the campaign, geographic region of the campaign, and the like. Individual attributes may refer to the attributes of an individual. Depending on how an individual relates to a particular workflow of the platform 100, the term “individual” may refer to a past donor to a campaign (e.g., a past donor to the current campaign or of a similar campaign of the organization), a supporter of a campaign, a lead of the campaign, a potential donor to a campaign, a contact of the organization or a supporter of the campaign, a random person used for machine-learning purposes, and the like. For example, an individual that previously donated to a similar campaign of the organization may be referred to as a past donor. If, however, that person becomes a supporter of the campaign, the individual may also be referred to as a supporter. Similarly, an individual appearing in a contact list of a supporter may be referred to as a contact and/or a lead. If that contact/lead is determined as a likely candidate to contribute to the campaign, the contact may also be referred to as a potential donor or a high priority lead. Examples of individual attributes of an individual may include, but are not limited to, a name of the individual, a gender of the individual, an education level of the individual, schools attended by the individual, an income level of the individual, an employment status of the individual, an employer of the individual, a geographic region of the individual, an address of the individual, interests of the individuals, social media posts of the individual, a degree of social media activity of the individual, past donations of an individual, philanthropic causes donated to by the individual, and the like.

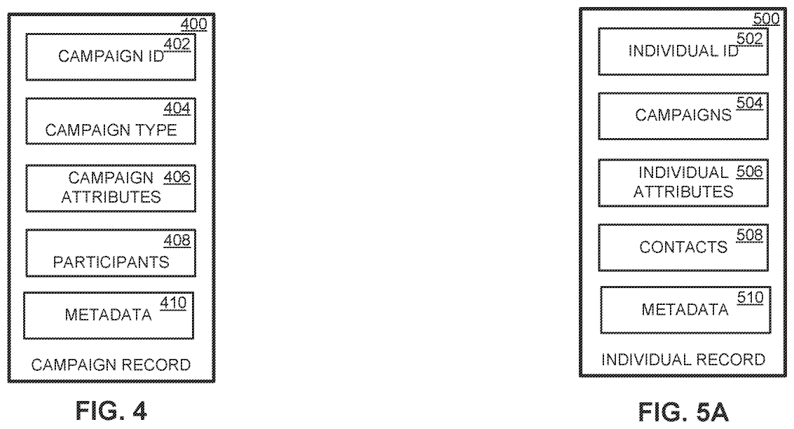

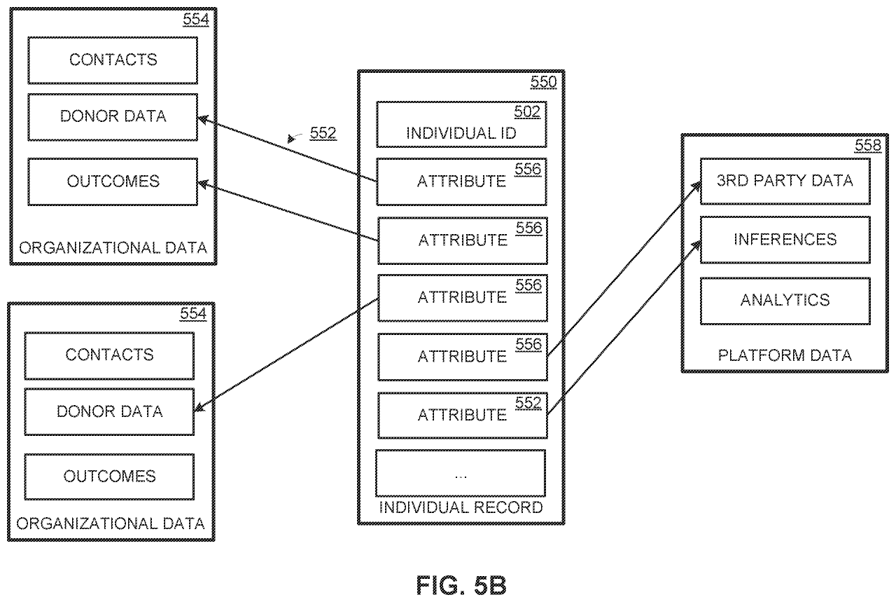

As will be apparent in this disclosure, the individual attributes of an individual and the campaign attributes may be used for a number of different applications, including training a donor prediction model on behalf of an organization, determining whether an individual is likely to support a campaign, determining whether an individual is likely to contribute to a campaign, generating machine-generated text that solicits contribution or support to a campaign, and the like. In embodiments, the campaign attributes of a campaign may be structured in a campaign record (see e.g., campaign record 400 in FIG. 4) and the individual attributes of an individual may be structured in an individual record (see e.g., individual records 500 in FIG. 5A and individual record 550 in FIG. 5B).

In embodiments, the platform 100 trains machine-learned prediction models (or “prediction model”) on behalf of campaigns and/or organizations. In these embodiments, each respective machine-learned prediction model may be trained specifically for a particular campaign or organization to predict an outcome given an input set of attributes (e.g., individual attributes), such that the prediction model is leveraged only for tasks relating to the particular campaign and/or organization and not for tasks relating to other campaigns of other organizations. The prediction models may be any suitable type of model (e.g., a decision tree, a random forest, a regression-based model, any suitable type of neural network, a Hidden Markov model, or the like). In some of these embodiments, a prediction model may be a look alike model that is trained to predict an outcome based on a high degree of similarity between the input attributes and one or more sets of attributes used to train the model. In embodiments, the prediction models may include donor prediction models that are trained to determine whether an individual (which may be referred to as a lead) is likely to donate to a campaign of the organization. In embodiments, the prediction models may include sponsor prediction models that are trained to determine whether an individual (which may be referred to as a lead) is likely to sponsor a campaign. As will discussed, the prediction models may be trained in part using historical donor data of the organization. Furthermore, in some embodiments, the platform 100 may synthesize negative outcome training data based on sets of individual attributes of random individuals, which are assigned negative outcomes (e.g., “did not donate” or “did not sponsor”). In these embodiments, the platform 100 may synthesize the negative outcome training data to compensate for the tendency of historical donor data to only include data relating to individuals that did contribute to the campaigns of an organization. In this way, the training data used to train a prediction model includes a realistic distribution of negative outcome training data and positive outcome training data.

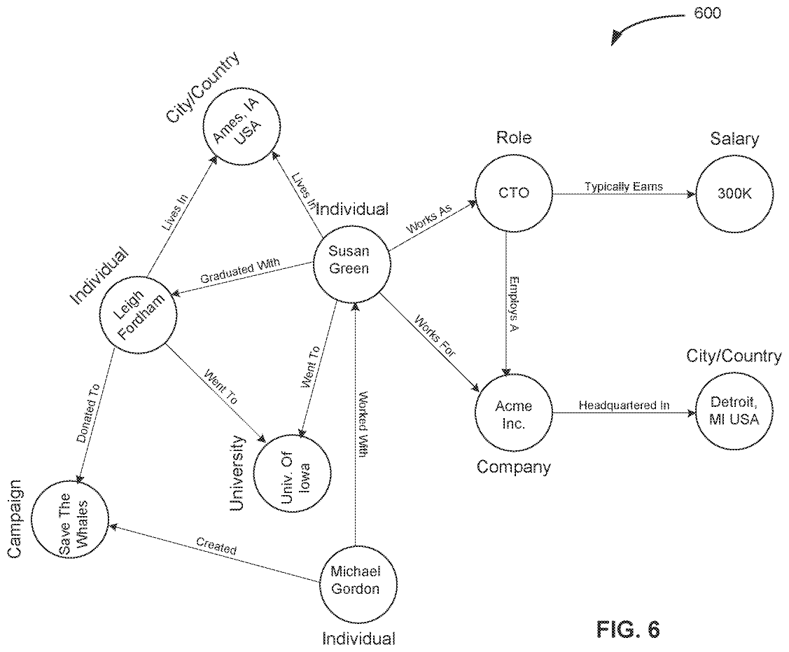

In embodiments, the platform 100 is configured to access and collect data relating to the individuals from multiple data sources (e.g., client organizations, user devices 108, content publishing platforms 110, websites, third party data sources 146, and the like) and to generate the individual attributes/individual records based on the collected data. In some embodiments, the platform 100 performs an identity resolution process that resolves individuals indicated in an organization's historical donor data and/or in third party data by deduping and enriching the individual attributes of individuals represented by the individual records (or profiles) and/or in the social graph (e.g., the social graph 600 depicted in FIG. 6), which improves the quality of the donor prediction models and the predictions made thereby.

In some embodiments, the platform 100 is configured to protect the data provided by an organization (also referred to as “protected organizational data”), such that any data provided by the organization that is deemed protected (e.g., historical donor data indicating donor names, donor outcomes, donor addresses, and the like) is only used in support of campaigns of the respective organization and is not comingled with the data provided by other organizations.

In operation, the platform 100 may leverage a donor prediction model on behalf of an organization to identify potential donors to solicit for contributions to a campaign of the organization. In embodiments, the platform 100 may generate an individual profile of an individual (which may be referred to as a lead profile of a lead) based on the attributes of the individual. The platform 100 may feed the individual profile of the individual to the donor prediction model, which determines a confidence score indicating whether the individual is likely to contribute to the campaign. If the confidence score exceeds a threshold, the individual is determined to likely to contribute to the campaign and the platform 100 may initiate solicitation of a contribution from the individual. In embodiments, initiating solicitation of a contribution may refer to outputting an individual profile of the potential donor (e.g., potential donor's name, potential donor's attributes, potential donor's contact information, and the like) to a user affiliated with the campaign (e.g., an employee or volunteer of the organization putting on the campaign), whereby the user can use the information contained in the individual profile to message or call the potential donor. For example, the platform 100 may present one or more individual attributes defined in the individual profile in a graphical user interface, whereby a user may view the individual attributes and may craft a message and/or may chat (e.g., phone call or text-based chat) with the potential donor using the individual attributes during the solicitation. In embodiments, initiating solicitation of a contribution/donation may refer to identifying prompts and/or recommendations that an affiliate of the organization can use in a message (e.g., an email, SMS message, or the like) or a conversation (e.g., phone-call, text-based chat) with the potential donor. In embodiments, initiating solicitation of a contribution/donation may refer to generating machine-generated text using a natural language processor that may be included in an email or other suitable electronic communication (e.g., SMS message, direct message, or the like). In these embodiments, the machine-generated text may include, for example, a subject line header (e.g., an email subject line header) and/or message body text. The machine-generated text may be presented to a user before being sent or may be automatically sent to the potential donor.

In some embodiments, the platform 100 enables “organization-to-lead” (O2L) campaigns. In an O2L campaign, the platform 100 may utilize machine-learned donor prediction models to identify potential donors to a campaign. A donor may be an individual that contributes monetary or time-based support to a campaign of an organization. For example, a donor may donate money or time (e.g., volunteering at an event or to go door-to-door to raise awareness to a cause) to the campaign. In embodiments, the platform 100 may initiate solicitation of a contribution to a campaign from a potential donor in response to identifying the potential donor.

In embodiments, the platform 100 enables “peer-to-peer” campaigns (or “P2P campaigns”). In a peer-to-peer campaign, the platform 100 may help the organization identify/enlist supporter that solicit contribution to the campaign. A supporter may refer to an individual that solicits contribution to the campaign from other potential supporter or donors. It is noted that a supporter may also be a donor, campaign initiator, an influencer, a user or the like. In embodiments, the platform 100 may allow a supporter to upload his or her contacts to the platform 100, whereby the platform 100 may generate profiles for each contact and may determine whether the contact is likely to contribute to the campaign using a machine-learned donor prediction model. In some embodiments, the platform 100 may identify potential donors to the campaign and may match one or more potential donors to a supporter based on the respective attributes thereof. For example, the platform 100 may match (e.g., probabilistically or deterministically) a potential donor to a supporter if the two individuals went to the same university or worked for the same company in the past. In embodiments, once a lead (e.g., a contact of the supporter or an unrelated individual) is identified by the platform 100 as a potential donor (that is, likely to contribute to the campaign), the platform 100 may initiate solicitation of a contribution to the campaign from the potential donor by the supporter. In embodiments, initiating a solicitation of a contribution by a potential donor in a P2P campaign is performed in substantially the same manner as in a O2L campaign. Thus, descriptions of solicitation of a contribution by a potential lead in the context of O2L campaigns are applicable to P2P campaigns, and vice-versa.

In embodiments, the platform 100 is configured to allow an entity (e.g., campaign creators) to create and manage one or more campaigns on behalf of an organization. In embodiments, the platform 100 may further include capabilities for generating personal profiles on the platform 100, identifying potential supporters for a campaign, training donor prediction models on behalf of organizations, generating and sending personalized communication to potential supporters and/or potential donors (collectively referred to herein along with the potential supporters as “leads”) to enlist support for a campaign, determining donor outcomes with respect to each lead, and/or updating a workflow associated with a campaign using the donor outcomes.

In embodiments, a campaign creator (e.g., a fundraiser for an organization, a manager of an organization, an activist affiliated with a cause, or the like) may create a new campaign on the platform 100 by providing campaign information relating to a fundraising campaign. Examples of different types of information that relates to a campaign may include a campaign type (e.g. non-profit fundraiser, for-profit fundraiser, or the like), a cause (e.g. art restoration, university endowment, building an animal shelter, or the like), a goal (e.g. donation amount USD500000), regulatory data (e.g. tax ID number), a campaign name, a start date, an end date, and the like. In embodiments, the platform 100 may allow the campaign creator to enter data and create content for or about the campaign that is published in a content publishing platform 110 via an API of the content publishing platform 110.

In some embodiments, the platform 100 may use the campaign information to identify leads to support and/or donate to the campaign. For example, in a peer-to-peer configuration, the platform 100 may identify supporters to the campaign, who may in turn enlist donors to the campaign. In embodiments, the platform 100 may initially generate a list of individuals (or “leads”) which may or may not be known to the campaign (such as from a database of contacts of the fundraising organization and/or a third-party database of individuals). The platform 100 may then leverage one or more prediction models that predict whether the leads potential supporters and/or donors based on the attributes of the individuals and/or attributes of the campaign. It is noted that the attributes of an individual may be referred to as “supporter attributes”, “donor attributes”, “contact attributes”, “person attributes” and/or “lead attributes”, depending on the workflow and where in the workflow such attributes are being used leveraged.

In some P2P embodiments, the platform 100 generates a message (e.g., an email, text, or the like) asking the supporter about willingness to provide support by making content with further leads from among the contacts of the supporter, such as a message containing a link by which the supporter can initiate the support of the campaign. In this example, by clicking the link (or otherwise initiating engagement, such as by interacting with an interface of the supporter's user device), the supporter initiates an action by the platform 100, whereby the platform 100 retrieves contact information for the supporter (e.g., LinkedIn™, Facebook™, email and other contact information in the social graph of the supporter), processes the contact information (e.g., using artificial intelligence as described further herein), identifies one or more leads having attributes that are well matched to the campaign, and generates a set of messages that the supporter can send (or that can be sent for the supporter) to the leads, asking the leads to engage in the campaign, such as by making donations and/or taking actions (which can include becoming supporters, leading to further iteration of the actions noted above). For example, once a supporter allows processing of the supporter's contacts with respect to a campaign to build a new wing to an art museum, the platform 100 may identify leads with respect to a supporter that include workplace colleagues of the supporter, friends of the supporter who are interested in art, fellow members of organizations of which the supporter is a member, alumni organizations, and/or any other contacts of the supporter who have donated to philanthropic causes in the past, have indicated interest in art and appear to have the capacity to help the campaign. In some embodiments, the platform 100 may identify leads using a machine learning approach (e.g., using k-means clustering or k-nearest neighbor clustering) and/or a rules-based approach. In using a machine-learning approach, the platform 100 may probabilistically identify leads that have attribute sets that most closely correlate (or “are nearest to”) to the attribute set of the supporter and/or the campaign. In using a rules-based approach, the platform 100 may execute a set of rules that configured to identify specific relationships between a lead and the campaign, the organization, and/or the supporter. In embodiments, the platform 100 may then generate one or more personalized messages and send to the identified leads so as to help a supporter enlist support for the campaign. In embodiments, generating personalized messages may include generating text that may be included in a message and may further include determining a style of communication (e.g., formal, informal, collegial, short, long, etc.) and a messaging medium (e.g., email, SMS, Facebook® post, WhatsApp® message, Twitter® direct message, and the like). Based on the response of a given lead to a personalized message, the platform 100 may determine a “donor outcome” for each message. Example donor outcomes can indicate: “ignored,” “responded,” “responded negatively,” “enlisted in the campaign,” “donated to the campaign,” “volunteered,” “reached out to other leads” and the like. The platform 100 then uses the donor outcome to update a workflow associated with a campaign. The donor outcomes can also be used to update or reinforce one or more donor prediction models that identified prospective donors, such as by adjusting weights that apply to a wide range of attributes that may be tracked by the system and that may help find the best prospective leads for a given campaign among the many contacts of the supporter. The donor outcomes can also be used for analytics purposes, such as for determining whether particular types of personalized messages are more or less effective in eliciting a positive donor outcome.

In embodiments, the campaign platform 100 may be configured to determine a predicted giving propensity of an individual (e.g., a lead). A predicted giving propensity (also referred to as a “giving propensity”) may be a metric that indicates an amount of money that an individual may be willing to give to a campaign. In embodiments, the platform 100 may determine the predicted giving propensity of an individual based on one or more individual attributes of the lead and/or one or more campaign attributes of the campaign. In embodiments, the platform 100 leverages a machine-learned prediction model to determine the predicted giving propensity of an individual. In embodiments, the machine-learned prediction model is trained on past outcomes relating to donation amounts of past donors to one or more campaigns (which may be organization specific or obtained from different organizations). In embodiments, the donor prediction model may be trained on individual attributes of donors, the donation amounts given by the past donors, and campaign attributes of the one or more campaigns. In embodiments, the donor prediction model is configured to receive a set of individual attributes of an individual (e.g., job title, estimated net worth, estimated income, estimated giving capacity, age, education level, schools attended, organization membership, interests, etc.) and the campaign attributes of a campaign and to output a predicted giving propensity of the individual.

In some embodiments, the set of individual attributes used to determine a giving propensity of an individual may include the giving capacity of an individual. In embodiments, the giving capacity is a campaign-agnostic attribute of the individual. For example, if a lead is a college student, the giving capacity may be relatively low (e.g., $10-$50), whereas a CEO of a company may have a much higher giving propensity (e.g., $10000-$100000), regardless of the campaign. A giving capacity of an individual may indicate an estimated limit to which an individual may give given economic-based attributes of an individual (and potentially some non-economic attributes) that may include, for example, an estimated net worth of the individual, the age of the individual, an estimated income level of the individual, and the like. The platform 100 may utilize lookup tables, scoring algorithms, rules-based algorithms, and/or the like to determine a giving capacity of an individual. In embodiments, the campaign platform may store the estimated giving capacity and/or predicted giving propensity of an individual in a record associated with the potential lead, in a record associated with the campaign, and/or in a social graph.

It is appreciated that other individual attributes may be relevant to determining the predicted giving propensity that are not necessarily economic-based but more affinity-based (e.g., an alum of a university may have a greater predicted giving propensity for causes relating to the university than for causes that are for local organizations that are not relevant to the individual). Non-limiting examples of non-economic features that may be used to determine a giving propensity may include, but are not limited to, schools attended by an individual, professional, social, political, or philanthropic affiliations of the individual, education level of an individual, a hometown of the individual, a current residence of the individual, a marital status of the individual, a parental status of the individual, and/or the like. Example of campaign features that may be used to determine a giving propensity may include a cause of a campaign, a type of the campaign (e.g., general fundraising or for a special project, capital investment, or the like), a size of the organization putting on the campaign, board members of the organization putting on the campaign, social, political, or religious affiliations of the organization putting on the campaign, and/or the like.

In embodiments, the campaign platform 100 may use the predicted giving propensity of a lead that is to be a potential donor to determine solicitation information. The solicitation information may be used to auto-generate personalized content for a predicted donor and/or may be output with a human who (e.g., an employee or volunteer of an organization putting on a campaign and/or a supporter of the campaign).

In embodiments, the solicitation information may include a suggested donation amount. In these embodiments, the suggested donation amount may be included in a message sent to the potential donor or communicated to the potential donor in a conversation with the potential donor. In embodiments, the campaign platform 100 may determine a suggested donation amount based on the predicted giving propensity of the potential lead and the goals of the campaign (e.g., how much the campaign is looking to raise, how many donors the campaign is looking to have, how many selectable options are included in a gift string, etc.). In other embodiments, the campaign platform 100 may determine the suggested donation amount by selecting a donation amount from a set of predefined donation amounts that are provided by the organization (e.g., from the campaign manager), whereby the campaign platform 100 may utilize a mapping of different giving propensity (or ranges of giving propensities) to different predefined suggested donation amounts.

In embodiments, the solicitation information may include a dynamic tailored gift string that is presented to the potential lead if/when the potential lead accesses the campaign platform (e.g., if/when the potential lead clicks on a link to support the campaign). In embodiments, a gift string is a graphical user interface element that has one or more selectable elements, where each selectable element corresponds to a different donation amount (e.g., a first element is an option to donate $10, a second element is an option to donate $20, a third element is an option to donate $30, and a fourth element is an option to donate a custom amount). A dynamic tailored gift string is a gift string where the donation amounts in the selectable elements can be varied depending on the individual accessing the page showing the gift string. For example, a potential lead that is determined to have a relatively low predicted giving propensity (e.g., a college student on a fixed income) may be presented the gift string with the amounts of: $10, $20, $30, $50, and a custom amount; whereas potential lead that is determined to have a relatively high predicted giving propensity (e.g., a CEO of a large company) may be presented a gift string with the amounts of ($1000, $2500, $5000, $10000, and a custom amount. In embodiments, the campaign platform 100 may determine the amounts to include in each respective dynamic tailored gift string based on the predicted giving propensity of the potential lead and the goals of the campaign (e.g., how much the campaign is looking to raise, how many donors the campaign is looking to have, how many selectable options are included in a gift string, etc.). In other embodiments, the campaign platform 100 may determine the amounts to include in each respective dynamic tailored gift string by selecting a gift string from a set of predefined gift strings that are provided by the campaign manager, whereby the campaign platform 100 may utilize a mapping of different giving propensity (or ranges of giving propensities) to different predefined gift strings. In these embodiments, the campaign platform 100 may determine the predicted giving propensity of a potential lead (e.g., in the manner described above) and then may select the dynamic gift string of the potential lead based on the mapping and the predicted giving propensity of the potential lead.

In embodiments, the platform 100 interacts with a set of user devices 108 associated with supporters over a network 110, such as to identify and communicate with other potential supporters or leads. The campaign platform 100 may also facilitate supporters to publish content corresponding to a campaign on a content publishing platform 110. Examples of content publishing platforms 110 include social networking sites, blogs, news sites, and the like. In embodiments, the content publishing platforms 110 may include messaging clients, whereby the supporter can transmit a personalized message to a lead via a direct message or email.

In embodiments, the platform 100 may execute one or more of a campaign management system 118, a data acquisition system 120, a lead prioritization system 122, an identity management system 124, a content generation system 126, a cognitive processes system 128, and a workflow system 130.

In embodiments, the campaign management system 118 allows a campaign creator to create and manage a campaign, as well as allowing supporters to help promote the campaign with their contacts.

In embodiments, the data acquisition system 120 acquires data from different data sources 132 and organizes such data into one or more data structures. Non-limiting examples of data sources include social networks 134, organization websites 138, contact lists 140, news articles 142, organizational client relationship management (CRM) system 144, proprietary third-party sources 146 (e.g., Full Contact™, Circle Back™, Tower Data™, and the like), and/or other suitable data sources. In embodiments, an organization affiliated with a campaign may provide the campaign platform with access to the organization's CRM system 144 (which may be hosted on sophisticated CRM solutions such as Salesforce.com, the organization's internal databases, and/or files such as spreadsheets maintained by one or more persons affiliated with the organization).

In embodiments, the lead prioritization system 122 identifies a set of leads (also referred to as a “lead list”) for a campaign. In some embodiments, lead prioritization system 122 identifies the leads in the lead list from a set of individual records the define individual attributes of individuals identified from one or more data sources 132. In embodiments, the lead prioritization system 122 may receive a list of contacts of the organization and/or of a supporter (which may be extracted from various sources and stored in the storage system 112 for use in the platform 100) and may determine the lead list based on the attributes of those contacts. In some embodiments, the lead prioritization system 122 may pare a list of individuals (e.g., contacts or individuals within a network) based on the attributes of the respective individuals and a set of attributes of the campaign. In some embodiments, the lead prioritization system 122 may score a set of leads, whereby the lead prioritization system 122 may rank the leads based on their scores.

In embodiments, the identity management system 124 generates individual profiles and/or individual records based on data relating to respective individuals. In some embodiments, the identity management system 124 is configured to perform an identity resolution process with respect to individuals. The identity resolution process may include resolving various identifiers (e.g., email addresses, mobile numbers, usernames, combinations of semi-unique identifiers, or the like) that correspond to a respective individual and enriching (and deduping) the attributes of the individual using the resolved identifiers. In embodiments, the identity management system 124 generates individual profiles and/or individual records based on the results of the identity resolution process. In some embodiments, the identity management system 124 is configured to generate individual records that protect data provided by organizations (referred to as “organizational data” or “protected organizational data”).

In embodiments, the content generation system 126 generates personalized content that is sent to individuals and/or posted on content publishing platforms 110. In some embodiments, the content generation system 126 generates personalized content that is included in electronic communications that are transmitted to potential supporters and/or potential donors. For example, the content generation system 126 may leverage the natural language processing capabilities of the cognitive processes system 128 to generate message headers and/or message body text that is intended to solicit a contribution from a potential donor. In some embodiments (e.g., P2P embodiments), the content generation system 126 may generate personalized content that is to be sent by a supporter to a lead, whereby the personalized content is generated based on the lead attributes of the lead, the supporter attributes of the supporter, and/or the campaign attributes of the campaign. In some embodiments, the supporter may approve the generated content provided by the content generation system 126 and/or make edits to the generated content, then send the content to various leads via email or other channels.

In embodiments, the cognitive processes system 128 performs one or more cognitive processes (e.g., machine-learning, artificial intelligence, and the like) on behalf of the platform 100. In some embodiments, the cognitive processes system 128 may implement one or more machine learning techniques to build, train, update or reinforce prediction models on behalf of campaigns and/or organizations. In embodiments, the cognitive processes system 128 may perform artificial intelligence tasks by, for example, leveraging the predictive models to make predictions regarding leads with respect to campaigns (including leads for additional supporters and donors). Examples of predictions include a likelihood that a lead is likely to engage with a campaign (e.g., donate to the campaign or volunteer for the campaign), an amount a donor is likely to donate to the campaign, a likelihood that a lead will respond to an email regarding the campaign, and the like.

In embodiments, the workflow system 130 supports various workflows associated with a campaign, including initial contacts, follow ups, donor outcomes, thank you notes, and the like.

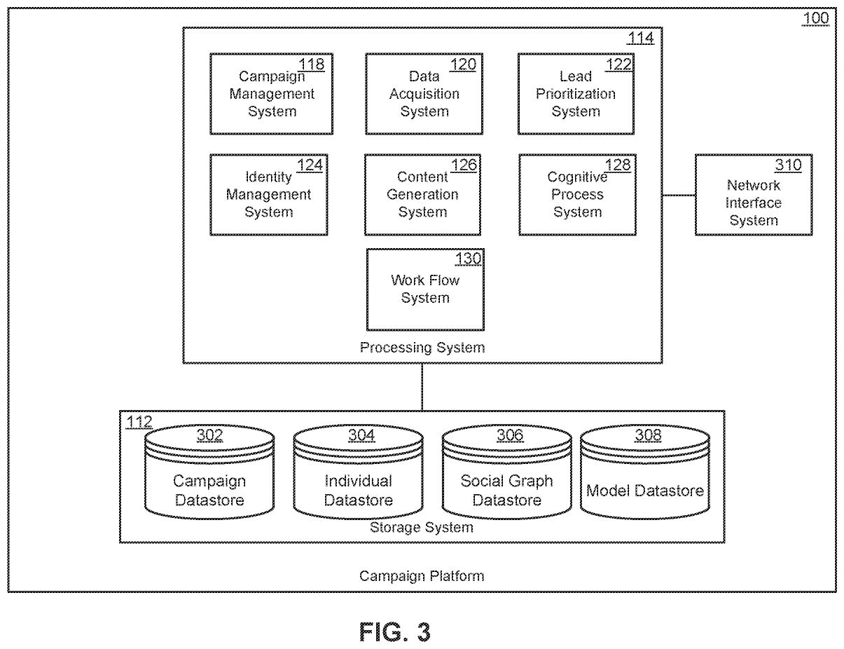

In embodiments, one or more of these subsystems may be implemented as micro services, such that other subsystems of the campaign management system 118 access the functionality of a subsystem providing a micro service via application programming interface (API). In some embodiments, the various services that are provided by the subsystems may be deployed in bundles that are integrated, such as by a set of APIs. Each of the subsystems are described in greater detail with respect to FIG. 3.

In embodiments, the campaign platform 100 can be implemented as one or more servers including a file server, domain server, internet server, intranet server, cloud server, print server and other variants such as secondary server, host server, distributed server and the like. The server may provide an interface to other devices including, without limitation, clients, other servers, printers, database servers, print servers, file servers, communication servers, distributed servers, social networks, and the like. In embodiments, user device 108 can include a smartphone, a tablet, a notebook computer, a personal digital assistant (PDA), or another type of computation or communication device. The network 110 can be a collection of individual networks, interconnected with each other and functioning as a single large network. Such individual networks may be wired, wireless, or a combination thereof. Examples of such individual networks include, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, fifth generation (5G) telecommunication networks, and Worldwide Interoperability for Microwave Access (WiMAX) networks.

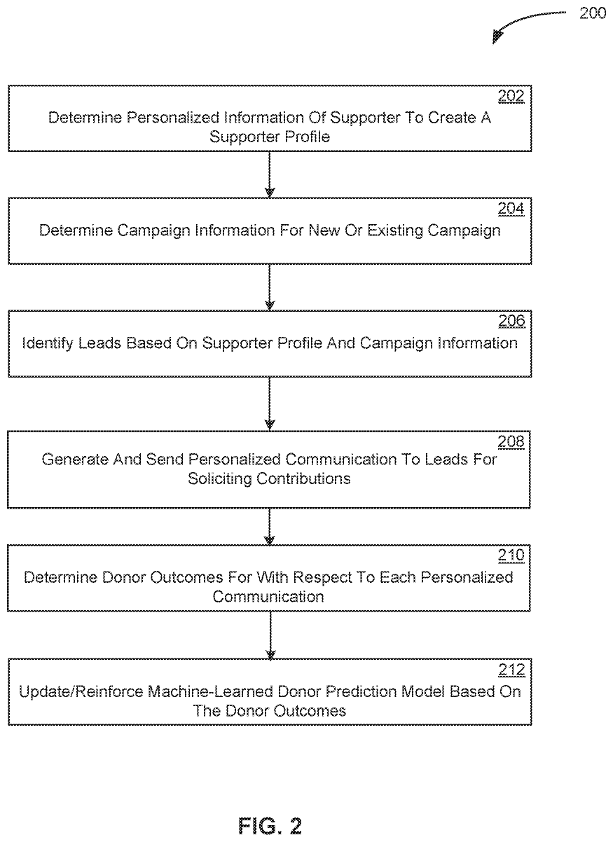

FIG. 2 illustrates a method 200 for automating a peer-to-peer fundraising campaign in accordance with embodiments of the systems and methods disclosed herein. The method is described with respect to a single supporter, the method may be performed with respect to multiple supporters. In embodiments, the method is executed in response to a supporter's request to support a campaign. The campaigns can be new campaigns or preexisting campaigns. The supporter may issue the request via a graphical user interface of the campaign platform 100 and/or by selecting a link (e.g., from an email asking the supporter to support the campaign).

At 202, personalized information of the supporter is determined and an individual record corresponding to the supporter is created using such information. The individual record may include personally identifiable information (e.g., name, age, gender, email address, mobile number, etc.), organizations (e.g., professional, philanthropic, universities attended, etc.), roles (e.g., job title, philanthropic boards, political campaigns, etc.), social network information (e.g., Facebook likes and/or groups, LinkedIn® endorsements, etc.), contacts (e.g., phone, email, social media account, FullContact™, LinkedIn®, Facebook®,), supported organizations (e.g., donor lists, campaign data and the like), consumer demographic political data (e.g., data sourced from L2™, Experian™) and various governmental data sources, financial data (e.g., data sourced from credit bureaus) and the like. In embodiments, the individual record may be generated using data provided by the supporter, data obtained from one or more data sources, and the like. In embodiments, the individual record may be generated using the results of an identity resolution process.

At 204, campaign information for the campaign that is supported by the supporter is determined. Examples of campaign information include campaign type (e.g. fundraiser, signature etc.), a cause (e.g. art restoration, disaster relief, clean water, wildlife conservation, education etc.), content (e.g., a description of the campaign, photographs, etc.), goals (e.g., a monetary amount or number of signatures), participants, regulatory data (e.g., tax ID number), and the like. The campaign information may also identify one or more machine-learned models that are used to predict a person's likelihood to support the campaign. In embodiments, the campaign information may be obtained from a campaign record of the campaign, which is generated at the campaign's creation.

At 206, potential contributors (e.g., potential supporters and/or potential donors) are identified based on the supporter information and campaign information. In embodiments, the platform 206 may identify a list of leads based in part on the contacts of the supporter and/or input provided by supporter. The platform 100 may ingest the supporter's contacts from any suitable source, including the user's user device (e.g., contact lists), a user's email accounts, a user's social media accounts, and the like. Additionally, in embodiments, leads may be identified by the campaign platform 100 based on attribute data collected from publicly available data sources and/or contact lists imported from other supporters. In these embodiments, the campaign platform 100 may identify leads that may be in the supporter's network, but not contacts of the user's (e.g., classmates, coworkers, participants in the same organizations, and the like) and/or individuals that strongly correlate to the supporter of the campaign (e.g., common interests, common causes, etc.). In some embodiments, if multiple supporters are linked with a lead, the platform 100 may determine which supporter should solicit a contribution from the lead. For example, the platform 100 may determine which supporter has the strongest relationship with the lead (e.g., based on the individual attributes of the lead in relation to the respective individual attributes of the respective supporters).

In embodiments, the campaign platform 100 may, for each identified lead, generate an individual profile for the lead. The individual profile of the lead may include attributes of the individual, which may be obtained from the organization's CRM, from publicly available data sources (e.g., social networking sites, organizational websites, and the like), from proprietary third-party data sources, and the like. In some embodiments, the campaign platform 100 may perform an identity resolution process for each respective individual to generate the individual profile, as is discussed throughout this disclosure.

In embodiments, the campaign platform 100 may feed an individual's attributes into a machine-learned prediction model (e.g., a donor prediction model) that is trained for the campaign and/or the organization of the campaign. In response, the prediction model outputs a prediction relating to the lead. In embodiments, the prediction may include a confidence score that indicates a degree of likelihood that the individual will donate or otherwise contribute to the campaign. In some embodiments, the campaign platform 100 may rank the individuals based on how likely they are to donate and/or otherwise contribute to the campaign. In some embodiments, the supporter may then select one or more leads from the list of leads, such that the platform 100 may generate personalized communications to the selected individuals on behalf of the user. In some embodiments, the platform 100 outputs any lead determined to likely donate to the campaign to a user device of the supporter, such that the supporter may solicit contributions from all of the leads.

At 208, personalized communication is automatically generated and sent to the leads for enlisting support to the campaign. In some embodiments, the platform 100 may generate the personalized communication using natural language processing techniques. The system may utilize attributes relating to the supporter, the information, and/or the campaign to generate the personalized communication. The platform 100 and/or the supporter may send the personalized communications to the selected leads. In some embodiments, the platform 100 may select a writing style (e.g., formal or informal, short or long, personal or impersonal) to use for generating personalized content for the user. In some of these embodiments, the platform 100 may leverage the campaign attributes and/or the individual attributes of the potential donor, and/or the individual attributes of the supporter to determine the writing style. In some embodiments, the platform 100 may select a messaging medium with which an electronic message containing the personalized content is sent to a potential lead. Examples of messaging mediums may include, but are not limited to, email, SMS, social media posts, messaging applications (e.g., WhatsApp®, Facebook Messenger®, Google Chat®, and the like), messaging functions of other types of applications (e.g., direct messages), and the like. In some of these embodiments, the platform 100 may leverage the campaign attributes and/or the individual attributes of the potential donor, and/or the individual attributes of the supporter to select the messaging medium.

At 210, donor outcomes are determined with respect to each personalized communication to the leads. For example, if a lead elects to donate or otherwise contribute to the campaign, the platform 100 may generate a positive outcome record corresponding to the lead. If expressly provided indication that the lead does not wish to support the communication, the platform 100 may generate a negative outcome record. If the lead does not respond, the platform 100 may generate a neutral outcome record. An outcome record may indicate a lead and the outcome with respect to a communication. Outcomes may be defined granularly (e.g., what did the lead agree to contribute) or broadly (e.g., positive, negative, or neutral). The outcome record may further include attributes of the lead, the communication that was sent to the lead, the medium that was used to send the communication to the lead (e.g., text message, email, social media messengers), time of day sent, day of the week sent, and/or other suitable information. The outcome records may be used to update a workflow associated with the campaign and/or to reinforce the models used to identify the lead.

At 212, one or more donor prediction models are updated/reinforced based on the donor outcomes. In these embodiments, the platform 100 may track outcomes related to a solicitation of a potential donor (e.g., whether the potential donor donated, whether the potential donor declined to donate, whether the potential donor ignored a personalized message, or the like) to reinforce the donor prediction model used to identify the potential donor as such. In these embodiments, the platform 100 may use the individual attributes of the potential donor and the outcome related to the potential donor as a training data pair that is used to reinforce the donor prediction model.

In embodiments, the platform 100 may monitor responses to a personalized communication, changes made to the personalized content by the supporter prior to transmission, and/or messaging medium selections by the supporter to determine an outcome relating to the personalized communication. In these embodiments, the platform 100 may use such feedback to improve text generation templates, to adapt/better select writing styles to different individuals, to select messaging mediums, and/or the like.

The method 200 of FIG. 2 is an example of a workflow of a P2P campaign. It is appreciated that some of the techniques discussed with respect to FIG. 2 may be applied to other types of campaigns, such as O2L campaigns.

FIG. 3 is an example system architecture of campaign platform 100 depicting various components, sub-components, sub-systems, software and other elements in accordance with embodiments of the systems and methods disclosed herein. In embodiments, the campaign platform may include a storage system 112, a processing system 114, and a network interface system 310.

The network interface system 310 includes one or more devices that may perform wired or wireless (e.g., Wi-Fi or cellular) communication. Examples of the network interface device 310 include, but are not limited to, a transceiver configured to perform communications using the IEEE 802.11 wireless standard, an Ethernet port, a wireless transmitter, and a universal serial bus (USB) port. The network interface system 310 may implement any suitable communication protocol. For example, the network interface system 310 may implement an IEEE 801.11 wireless communication protocol to effectuate wireless communication with external user devices via a wireless network.

The storage system 112 may include one or more computer readable storage mediums (e.g., hard disk drives and/or flash memory drives). The storage mediums may be located at the same physical location or distributed at different physical locations (e.g., different servers and/or different data centers). The storage system 112 may store one or more of data lakes storing raw data. The data lake may be populated with the data obtained by the data acquisition system 120 and may be in structured, unstructured or semi-structured form. In some embodiments, the data lake is a Hadoop™ data lake an Apache Spark™ data lake, or a Mongo™ data lake.

In embodiments, the storage system 112 stores one or more data stores. In some embodiments, the storage system 112 stores a campaign datastore 302, an individual datastore 304, a social graph datastore 306, and/or a model datastore 308. Each datastore may include files, records, and/or databases. In embodiments, the campaign datastore 302 stores data relating to the campaigns that are supported by the platform 100. In some of these embodiments, the campaign datastore 302 stores campaign records. In embodiments, the individual datastore 304 stores data relating to the individuals that are known by the platform 100, including data relating to supporters, leads, contacts, donors, and other suitable individuals. In some of these embodiments, the campaign datastore 302 stores individual records. In embodiments, the social graph datastore 306 stores one or more social graphs that link entities (e.g., campaigns, individuals, organizations, places, and the like) based on their attributes. In embodiments, the model datastore 308 stores machine-learned models, including machine-learned prediction models that are trained by the platform 100 on behalf of respective organizations and/or the campaigns of the organizations. The storage system 116 may store additional or alternative datastores without departing from the scope of the disclosure.

The processing system 114 may include one or more physical processors that execute computer readable instructions and memory (e.g., RAM and/or ROM) that stores the computer readable instructions. In embodiments where the processing system 114 includes more than one processor, the processors may operate in an individual or distributed manner. Furthermore, in these embodiments the two or more processors may be in the same computing device or may be implemented in separate computing devices (e.g., rack-mounted servers at one or more physical locations). In embodiments, the processing system 114 may execute a campaign management system 118, a data acquisition system 120, a lead prioritization system 122, an identity management system 124, a content generation system 126, a cognitive processes system 128, and a workflow system 130.

In embodiments, the campaign management system 118 manages the entire campaign process for new and existing campaigns. This includes generating new campaigns at the request of a campaign creator, receiving relevant information regarding the campaign (e.g., description, goals, donations sought, donation amount target, active dates, and the like), generating campaign records that define one or more attributes of the campaign (and/or the organization thereof), generating a webpage and/or application page based on the contents of the campaign record, updating the campaign records of a campaign (e.g., updating the total amount of money collected each time a new donation comes in, updating the participants when new supporters join), determining donor outcomes (e.g., who donated, how much, when, and the like), and/or sending communications to supporters and/or leads.

In embodiments, the campaign management system 118 may implement a graphical user interface to receive relevant information regarding the campaign from the campaign creator. In response to receiving the information, the campaign management system 118 may generate a campaign record based on the received information. In embodiments, the campaign management system 118 may generate a webpage and/or application page based on the contents of the campaign record.

In embodiments, a campaign record may be defined according to a suitable schema that may, for example, include a campaign identifier, campaign type, campaign attributes, campaign participants including supporters and other leads and any suitable metadata. In embodiments, a campaign data record may indicate one or more machine-learned prediction models (e.g., donor prediction models) that are used in connection with the campaign. In embodiments, the campaign data records for the different campaigns that are hosted or have been hosted by the campaign platform 100 are stored in a campaign datastore 302.

FIG. 4 illustrates an example schema of a campaign record in accordance with embodiments of the systems and methods disclosed herein. In embodiments, the campaign record 400 includes a campaign identifier 402 (e.g., a unique identifier that corresponds to the campaign), a campaign type 404 (e.g., fundraiser, pledge drive, for profit campaign, etc.), campaign attributes 406 (e.g., name of the campaign, name of the campaign initiator, description of the campaign, keywords of the campaign, goals of the campaign, active dates, and the like), participants 408 (e.g., person identifiers of campaign initiators, supporters, donors, other leads, and the like), and any suitable metadata 410 (e.g., creation date).

Referring back to FIG. 3, data acquisition system 120 obtains various types of data from different data sources 132 and organizes that data into one or more data structures. In embodiments, the data acquisition system 120 is configured to obtain data relating to an organization that is organizing a campaign and/or individuals that are affiliated with the campaign or may be contacted to support a campaign.

In embodiments, the data acquisition system 120 obtains data relating to a campaign from a CRM system 144 (FIG. 1) of the organization affiliated with the campaign. As previously discussed, an organization's CRM system 144 may include the organization's data stored on a third-party CRM solution, an organization's proprietary databases, and/or files (e.g., spreadsheets) maintained by the organization's file system. The campaign organizer may provide, for example via the campaign management system 118, any requisite information to grant the data acquisition system 120 access to the organization's CRM system, including API keys or file system paths. In response to the received information, the data acquisition system 120 may request or otherwise obtain the organization's data. In embodiments, the data acquisition system 120 may obtain contacts of the organization, as well as any profile data associated with the contacts of the organization. The profile data of a contact may include a name of the contact, an address of the contact, an email address of the contact, social media accounts of the contact, a role of the contact (e.g., donor, non-monetary contributor, etc.), an amount of donations given by the contact, outcomes related to the contact (e.g., donated/did not donate), other organizations that the contact donates to or otherwise contributes to, a net worth of the contact, etc. In embodiments, the data acquisition system 120 may obtain the historical donor data of an organization. The historical donor data 120 may be received from any suitable data source, including an upload by the organization (e.g., a spreadsheet or proprietary file containing information on previous donations to the organization), a CRM platform, or the like.

In embodiments, the data acquisition system 120 may generate an individual record for each contact of the organization. In some embodiments, the data acquisition system 120 may enrich an individual record of a contact with additional data relating to the contact that is obtained from alternative data sources, including websites, social media platforms, company websites and organizational charts, third-party proprietary data sources, and the like. In some embodiments, the platform may store a third-party data that is maintained by a third-party data source. In these embodiments, the data acquisition system 120 may process, index, and/or access the third-party data. In some embodiments, the data acquisition system 120 may crawl the alternative data sources (e.g., a social networking platform, news articles, and/or company websites) with one or more crawlers to obtain additional data relating to the contact. Additionally or alternatively, the data acquisition system 120 may request data relating to the client from a 3^{rd} party proprietary database 146 (FIG. 1). The data acquisition system 120 receives the additional data and may update the individual record of the contact with the additional data to enrich the individual record of the contact. In some embodiments, the data acquisition system 120 may dedupe the additional data and/or may disambiguate the data (e.g., identity resolution) to ensure that the individual record does not contain data of another individual with the same name as the contact or does not include repeated attributes.

In embodiments, data acquisition system 120 may obtain data relating to supporters from the supporter and/or from one or more data sources. In embodiments, a supporter may provide information relating to the supporter via a graphical user interface. For example, the supporter may provide his or her name, occupation, address, email address, phone number, interests, and the like. The data acquisition system 120 may also deploy one or more crawlers to crawl different websites, social media platforms, and/or applications and/or may leverage one or more APIs to retrieve data from external data sources 132 that obtain additional information relating to the supporter. The data acquisition system 120 may then organize the obtained data into appropriate data structures. For example, individual records based on data collected regarding individuals may be stored in database records, arrays, or tables.

In embodiments, the data acquisition system 120 obtains data relating to contacts of the supporters of a campaign and/or other individuals in a respective network of the supporters. In embodiments, the data acquisition system 120 may obtain the contacts of a supporter from a user device 108 of the supporter. Additionally or alternatively, the supporter may provide a list of accounts (e.g., social media accounts, email accounts, and the like) via a graphical user interface. The data acquisition system 120 may then retrieve data from one or more data sources 132 about one or more identified contacts and/or individuals in a supporter's network. For example, data acquisition system 120 may implement one or more crawlers to crawl different websites, social media platforms, and/or applications and/or may implement an API to retrieve data from external data sources 132 or supporter user devices 108 (e.g., various contact lists from supporter's phone or email account). The data acquisition system 120 may then organize the obtained data into appropriate data structures. For example, individual records based on data collected regarding individuals may be stored in database records, arrays, or tables.

FIG. 5A illustrates an example schema of an individual record 500 in accordance with embodiments of the systems and methods disclosed herein. In the example, each individual record may correspond to a respective individual and may include or point to a unique person identifier 502 (e.g., username or value) of the individual, campaigns 504 includes campaigns the individual contributes to (e.g., a list of campaign identifiers), person attributes 506 (e.g. age, gender, location, job, company, affiliated charities/philanthropic causes, universities attended, degrees held, predicted income, and the like), a list of contacts 508 of the individual, outcomes associated with the individual, and any suitable metadata 510 (e.g., date joined, dates contributed, and the like). In embodiments, the individual records are stored in a person datastore 304. Each individual record may correspond to an individual and may be organized according to any suitable schema.

Referring back to FIG. 3, in embodiments, the identity management system 124 interfaces with the data acquisition system 120 to manage the identities of individuals with respect to the system. As discussed, in embodiments, identity information of individuals (e.g., a supporter, a donor, a lead, and the like) may be imported from different information providers and data providers, as well as obtained/crawled from data sources such as websites, social media platforms, and the like. In embodiments, the identity management system 124 performs identity resolution, which may include identity stitching, identity normalization, deduping, and the like. For example, the identity management system 124 may combine individual data of an individual that is obtained from/associated with multiple social networking profiles and multiple email addresses. In some embodiments, the identity management system 124 may perform an identity resolution process to associate multiple social media networking profiles using one or more unique identifiers of an individual (e.g., username, email address, mobile number, etc.). In response to identifying the multiple social media profiles, the identity management system 124 may combine information from the multiple social networking profiles into a single individual record and/or individual profile and may select a single email address as the contact point for the person.

In embodiments, the identity management system 124 finds and aggregates disparate pieces of information (e.g., individual attributes) relating to the individual using two or more third party data sources using a unique identifier of the individual. In some embodiments, the identity management system 124 may query an attribute-based data source using a unique identifier of the individual (e.g., using an email address or mobile number). In embodiments, the attribute-based data source is a third-party data source that is maintained by crawling the internet for individual attribute data and/or collecting individual attribute data provided by owners of said data. In response, the identity management system 124 obtains a set of individual attributes relating to the individual, including semi-unique identifiers of the individual (e.g., combinations of an age of the individual, a name of the individual, current or former employers of the individual, current or former residences of the individual, and/or the like). The identity management system 124 may then query a contact-based data source using a known unique identifier of the individual and/or combinations of semi-unique identifiers of the individual. In embodiments, the contact-based data source is another third-party data source that aggregates related unique identifiers of individuals (e.g., email addresses, known phone numbers, physical addresses, and/or the like) and is maintained by crawling the internet for individual contact data and/or collecting individual contact data provided by owners of the individual contact data. The contact-based data source may return other unique identifiers and/or semi-unique identifiers of the individual. In embodiments, the identity management system 124 then re-queries the attribute-based data source with the other unique identifiers and/or the semi-unique identifiers of the individual to obtain an additional set of attributes relating to the individual. The identity management system 124 (or the data acquisition system 120) may then dedupe and combine the attributes obtained from the multiple passes to obtain an enriched set of individual attributes. In some embodiments, the identity management system 124 may query additional attribute data sources (e.g., other third-party data sources) with the unique identifiers of the individual and/or the semi-unique identifiers of the individual to further enrich the individual attributes of the individual.

In some embodiments, the identity management system 124 is configured to protect the data provided by an organization (also referred to as “protected organizational data”), such that any data provided by the organization that is deemed protected (e.g., historical donor data indicating donor names, donor outcomes, donor addresses, and the like) is only used in support of campaigns of the respective organization and is not comingled with the data provided by other organizations. For example, in training a donor prediction model that is used to predict whether individuals are likely to donate to a particular campaign of a particular organization, the historical donor data of the particular organization is used to train the donor prediction model, but is restricted from being used to train donor prediction models that are leveraged by other campaigns. In embodiments, however, platform data that is collected, derived, or otherwise obtained by the platform 100, included inferences relating to an individual that are made using organizational data of an organization may be used by the platform 100 on behalf of other campaigns or organizations. For example, an organization may upload historical donor data to the platform 100 that lists a set of past donors (e.g., a name and a unique identifier of the donor, such as an email address of the donor) and a donation outcome (e.g., how much was donated to the campaign). In this example, the donor outcomes associated with the individual with respect to the organization are considered protected organizational data and cannot be comingled with other data on behalf of other organizations; while additional individual attributes learned by the platform 100 via, for example, the identity resolution process, is platform data and may be used on behalf of other organizations. In embodiments, outcomes relating to activity data of individuals (e.g., whether they respond to personalized messages and/or other solicitations), personalized content, selected writing styles, and/or selected messaging mediums are considered platform data.

In some embodiments, the identity management system 124 (or the data acquisition system 120) structures individual records in a manner that prevents commingling of organizational data. FIG. 5B illustrates a portion of an example individual record 550 that manages protected organizational data. In embodiments, an individual record 550 may include one or more references 552 that point to protected organizational data 554 of respective organizations. For instance, in some of these embodiments, individual attribute data 556 in an individual record that belongs to a particular organization may be represented using a reference to the organization's data, rather than the value of the individual attribute itself. In these embodiments, the reference 552 may include metadata that indicates to the platform 100 on behalf of which organization a particular attribute 556 may be used. In embodiments, platform data 558 may also be referenced in the record 550, such that the platform 100 is granted permission to use any platform data 558 pointed to by the individual record for the tasks of any organization. In this way, the organizational data 554 of an organization may be protected from being used by an unauthorized organization but platform data 558 may be used to improve the performance across the platform 100.

In some embodiments, the identity management system 124 may be configured to determine a giving propensity of respective individuals based on their attributes. In these embodiments, a campaign affiliate and/or a supporter of a campaign may be provided with a prompt when a high value potential donor is identified. Additionally or alternatively, a campaign affiliate and/or a supporter of a campaign may be provided a suggested donation amount and/or gift string that is determined based on the potential donor's giving propensity. As discussed, the predicted giving propensity may be a metric that indicates an amount of money that a potential donor may be able to give based on one or more attributes of the potential individual. For example, some individuals may be inclined to give lesser amounts (e.g., $10-$50) and their respective attributes may be indicative of their giving propensity; while other individuals may have much higher giving propensities (e.g., $10000-$100000) and their respective attributes may be indicative of such giving propensities. It is appreciated that while economic features such as income and job title may be indicative of giving propensities, other features may be relevant to determining the predicted giving propensity that are not necessarily economic-based but more affinity based (e.g., an alum of a university may have a greater predicted giving propensity for causes relating to the university than for causes that are for local organizations). In embodiments, a giving propensity prediction model trained on past monetary donation outcomes relating to donation amounts of different individuals may be configured to receive the individual attributes of a potential donor (e.g., job title, estimated net worth, age, education level, schooling, region, etc.) and may output a predicted giving propensity of the potential lead. In embodiments, the giving propensity prediction model is a regression-based model. The giving propensity prediction model may be any other suitable type of model, however. In embodiments, the giving propensity prediction model is campaign agnostic and is not trained on campaign attributes. In other embodiments, the giving propensity model is campaign-specific or is trained using campaign attributes, such that the relationship between the individual features of an individual and the campaign attributes of the campaign influences the predicted giving propensity of an individual. In embodiments, the identity management system 124 (or another component of the platform 100) may leverage the giving propensity prediction model to determine a giving propensity of an individual determined to be a potential donor. In embodiments, the giving propensity of a potential donor may be provided as solicitation information and/or may be used to generate a customized gift string.

Referring back to FIG. 3, in embodiments, relationship data and entity data relating to one or more persons may be stored in a graph data structure. In embodiments, data acquisition system 120 generates and maintains one or more social graphs based on the retrieved data. In some embodiments, the social graph datastore 306 may store the one or more social graphs.

FIG. 6 illustrates an example of a social graph 600 as stored in the graph datastore 306 and storing the relationship data in accordance with embodiments of the systems and methods disclosed herein. A social graph 600 may be specific to an organization or may be a global social graph. The social graph 600 may be used in many different applications (e.g., identifying a list of leads, making predictions regarding leads, and/or generating content). In embodiments, a social graph 600 may be a graph database, where data is stored in a collection of nodes and edges. In some embodiments, a social graph 600 has nodes representing entities and edges representing relationships, each node may have a node type (also referred to as an “entity type”) and an entity value, each edge may have a relationship type and may define a relationship between two entities. For example, a person node may include a person ID that identifies the individual represented by the node and a company node may include a company identifier that identifies a company. A “works for” edge that is directed from a person node to a company node may denote that the person represented by the edge node works for the company represented by the company node. In another example, a person node may include a person ID that identifies the individual represented by the node and a campaign node may include a campaign identifier that identifies a campaign. A “donated to” edge that is directed from a person node to a campaign node may denote that the person represented by the person node donated to the campaign represented by the campaign node. Furthermore, in embodiments, an edge or node may contain or reference additional data. For example, a “donated to” edge may include a monetary amount that indicates an amount that was donated to a campaign by a person. The social graph(s) 600 can be used in a number of different applications, which are discussed with respect to the cognitive processes system 128.

Referring back to FIG. 3, in embodiments, the lead prioritization system 122 determines a lead list corresponding to a supporter, such as based on one or more data items relating to the supporter. For example, the lead prioritization system 122 may utilize a supporter's contacts, the individual datastore 304, and/or other suitable data sources to identify a lead list. For example, in some embodiments the lead generation 122 may import the contacts of a user (e.g., supporter, campaign creator, or the like) or of an organization (e.g., via an API of an organization's CRM) and may extract the email addresses and/or phone numbers of the contacts. In another example, the lead prioritization system 122 may identify different individuals represented in the individual datastore 304 as being leads. In embodiments, the lead prioritization system 122 may leverage the cognitive processes system 128 to pare the lead list. For example, the system may use the artificial intelligence techniques (e.g., neural networks or regression models) and/or clustering techniques to identify leads that have minimum degree of correspondence with an organization, a campaign, and/or a supporter of the campaign. In some of these embodiments, the lead list may be pared by identifying a set of individuals that have one or more attributes that positively correlate with an organization, a campaign, and/or a supporter of the campaign.

In embodiments, the content generation system 126 works in combination with the cognitive processes system 128 to generate text using natural language generation techniques. In some of these embodiments, the content generation system 126 generates personalized content that can be used in, for example, a communication to a lead (e.g., from a supporter to a potential donor or from an organization to a potential donor) and/or a post on a content publishing platform 110 (e.g., a social media post, a blog post, or the like). The personalized content may be included in any suitable format, including but not limited to an email, text message, a direct message, an article, and/or a social media post. In embodiments, the personalized content may be a message body and/or in a subject line header that is included in an electronic message. In some embodiments, the personalized content is body text that is included in a social media post or a blog post.

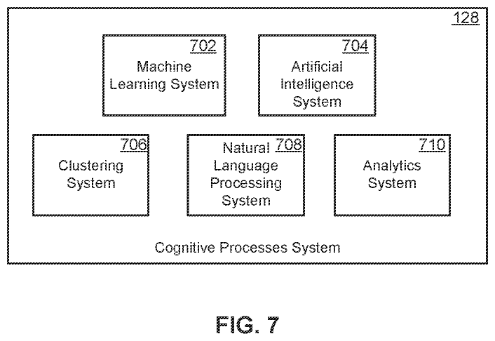

In embodiments, the personalized content is generated using text generation templates and customized using artificial intelligence based on individual attributes of a potential donor, campaign attributes of a campaign, and/or individual attributes of a supporter (the latter in P2P campaigns). The content generation system 126 may be seeded with a set of text generation templates. In embodiments, the content generation system 126 may identify or be provided with one or more prompts to use in a communication. The content generation system 126 may select the appropriate text generation templates based on the prompts and then may leverage a natural language processing system 708 (see e.g., FIG. 7) of the cognitive processes system 128 to generate snippets of text using the selected templates and one or more relevant attributes (e.g., individual attributes and/or campaign attributes). In embodiments, the text generation templates may be learned by the natural language processing system 708 (see e.g., FIG. 7) using a corpus of text created by humans (e.g., emails, text messages, social media posts, articles, books, and/or the like), and which may be further learned using feedback relating to the relative success (or lack thereof) of generated content when presented to a potential donor (or other individuals).

In embodiments, the content generation system 126 may customize one or more aspects of the personized content for individuals based on one or more individual attributes of the intended recipient or sender. For example, the content generation system 126 may select one or more of a length of the content, a mood of the content, the formality level of the content, a messaging medium to use for delivering the content, and/or the like. For example, close contacts (such as indicated by high frequency of contact or closeness in a social graph 600) may be presented with shorter, less formal communications than communications intended for more distant contacts. In another example, the content generation system 126 may select to create less formal content and to use messaging applications when messaging younger leads and may select to create more formal content and to use email when messaging older leads. In embodiments, the content generation system 126 may select the templates that are to be used to generate the content based in part on the selections relating to the content length, mood, formality, and/or messaging medium. The content generation system 126 may use a machine learning approach or a rules-based approach to make these determinations. Furthermore, the cognitive processes system 128 may monitor outcomes relating to the personalized content to reinforce models and/or rules that determine content length, mood, formality, and/or messaging medium.

In embodiments, a supporter, employee, or volunteer of the organization may approve the personalized content provided by the content generation system 126 or may make edits to the generated content, then send the personalized content via email or other suitable messaging mediums. In some of these embodiments, edits to the text by a user (e.g., supporter/employee/volunteer) in the selected messaging medium may be sent to the cognitive processes system 128, which in turn may monitor the efficacy of the edits to improve the text generation templates. In some embodiments, the generated content may be sent directly to the recipient without presentation to a human prior to transmission.

In embodiments, the cognitive processes system 128 may perform machine learning processes, artificial intelligence processes, clustering processes, natural language processing processes, model-based processes, rule-based processes, and/or analytics processes.

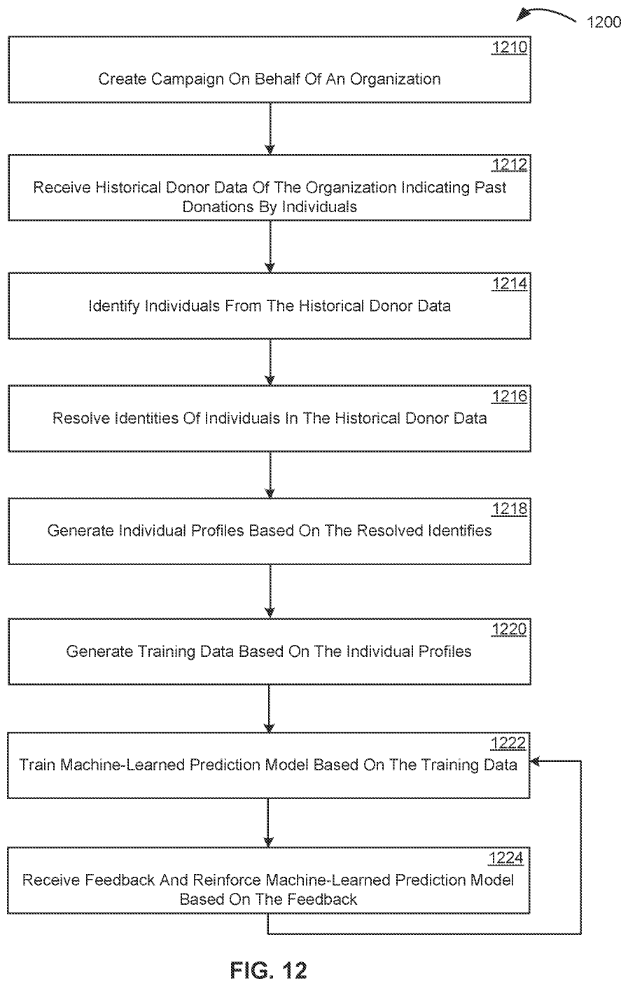

In embodiments, the cognitive processes system 128 trains machine learning processes may train models (e.g., various types of neural networks, regression-based models, and other machine-learned models). In embodiments, the various models are stored in a model datastore 308 in storage system 112. One example of such machine learned model is a donor prediction model. The donor prediction model may be trained using training data which may be collected or generated for training purposes. Such models may then be updated or reinforced based on donor outcomes received from one or more feedback sources. Examples of training the donor prediction models are described throughout the disclosure (see e.g., FIG. 7 and FIG. 12). In some embodiments, the cognitive processes system 128 may synthesize training data to improve the performance of the prediction models. In these embodiments, the cognitive processes system 128 may obtain individual attributes of random individuals (e.g., individuals listed in third party data sources) and may generate an individual profile for each respective individual. In some of these embodiments, the cognitive processes system 128 may assign negative outcomes to the synthesized individual profiles, so that the training data used to train a model has a more statistically accurate distribution of outcomes.

In embodiments, cognitive processes system 128 may implement artificial intelligence processes to make predictions regarding leads with respect to campaigns. Examples of predictions include a likelihood that a lead is likely to engage with a campaign (e.g., donate to the campaign or volunteer for the campaign), an amount a lead is likely to donate to the campaign, a likelihood that a lead will respond to an email regarding the campaign, and the like. In embodiments, cognitive processes system 128 may also implement clustering processes for identifying leads, natural processing processes for generating personalized communication for the leads and analytics processes for performing analytics relating to various aspects of the campaign platform 100.

FIG. 7 illustrates an example cognitive processes system 128 in accordance with embodiments of the systems and methods disclosed herein. In this example, the cognitive processes system 128 includes a machine learning system 702, an artificial intelligence (AI) system 704, a clustering system 706, a natural language processing system 708, and an analytics system 710.

In embodiments, machine learning system 702 may train models, such as predictive models (e.g., various types of neural networks, regression-based models, and other machine-learned models). In embodiments, the training can be supervised, semi-supervised, or unsupervised. In embodiments, training can be done using training data, which may be collected or generated for training purposes. In embodiments, machine learning system 702 trains a donor prediction model that receives campaign attributes and lead attributes and outputs one or more predictions regarding the lead with respect to the campaign. In some embodiments, the donor prediction models are trained using data pertaining to individual organizations and their campaigns. In these embodiments, the machine learning system 702 may train a prediction model using data obtained from an organization's CRM system 144 and any data obtained in response to data obtained from an organization's CRM system 144 to train the machine learned model. In these embodiments, a prediction model may be trained using attributes of the campaign (e.g., what the campaign is directed to, the amount to be raised, minimum or maximum donation amounts, etc.), attributes of individuals that are in the CRM, attributes of those individuals obtained from other data sources, and outcomes associated with those individuals (e.g., donated, contributed, did not donate or contribute). In some embodiments, donor prediction models may be trained using data collected from a collection of organizations. In these embodiments, a prediction model may be trained using attributes of campaigns (e.g., what the campaign is directed to, the amount to be raised, minimum or maximum donation amounts, etc.), attributes of organizations (a location of the organization, the name of the organization, the type of the organization, etc.), attributes of individuals that are in the CRM, attributes of those individuals obtained from other data sources, and outcomes associated with those individuals (e.g., donated, contributed, did not donate or contribute).

In some embodiments, the machine learning system 702 selects the types of attributes that are used to train a prediction model. For example, the machine learning system 702 may implement Principal Component Analysis (PCA) to extract the features in the training data that correlate to the outcomes in the training data. In this way, the machine learning system 702 may reduce the number of attributes that are used to train a prediction model (which also reduces the number of attributes that are used to obtain a prediction). The machine learning system 702 may use additional or alternative feature engineering techniques to select the relevant attributes for a particular training task.

In some embodiments, the machine learning system 702 (or another suitable system) generates synthesized training data to supplement training data corresponding to real-world outcomes (e.g., historical donor data). In these embodiments, the machine learning system 702 may generate negative outcome profiles for a number of random individuals, whereby a negative outcome profile includes the individual attributes of a random individual and is assigned a negative outcome. In some embodiments, the individual attributes of multiple individuals may be combined and assigned a negative outcome. In embodiments, the number of random individual profiles that are generated and assigned negative outcomes may be determined based on the amount of positive outcome profiles. For example, if it is determined that 95% of solicitations for contributions end in negative outcomes, then the machine learning system 702 may generate 19 negative outcome profiles for each positive outcome profile used in the training data.

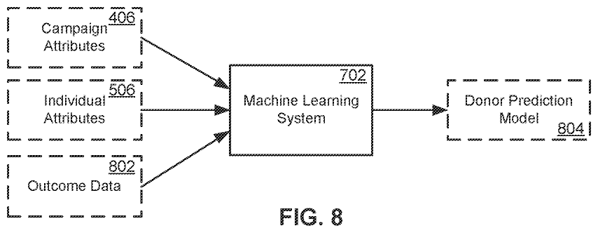

FIG. 8 illustrates an example of a machine learning system 702 training a donor prediction model in accordance with embodiments of the systems and methods disclosed herein. In embodiments, machine learning system 702 receives campaign attributes 406, individual attributes 506 of individuals, and donor outcome data 802 for each individual that indicates a respective outcome of the individual as inputs to train a donor prediction model 804. In embodiments, the individual attributes 506 and the outcome data 802 may be obtained from an organization's CRM system 144 or from other suitable data sources and/or may be synthesized. In embodiments, a prediction model 804 receives the attributes of an individual and/or a campaign, and outputs one or more predictions indicating a likelihood of whether the individual is likely to contribute in the campaign. Examples of predictions may be whether a potential lead (e.g., a contact of a supporter or donor) will engage with a campaign, whether the potential lead will donate to a campaign, an amount that the potential lead might donate to a campaign, whether the potential lead will respond to an email, whether the potential lead will become a supporter who contacts other leads, and the like.

In embodiments, the machine learning system 702 trains a model based on training data and one or more hyper-parameters relating to the specific machine learning algorithm being used. The hyper-parameters are parameters that pertain to the machine-learned model being trained and may be specific to the type of machine learning algorithm being used. For example, in training a random forest model, the hyper-parameters may include a number of decision trees to include in the forest. More decision trees in a random forest may result in better predictions, but at the cost of added computational resources. In another example, in training a neural network, the hyper parameters may include a number of layers in the neural network.

In embodiments, machine learning system 702 may generate and/or receive vectors containing campaign attributes 406 (e.g., campaign type, campaign cause, amount sought, contents of a communication, or the like), person attributes 506 (e.g., age of a lead, company of the lead, position of the lead, estimated income of the lead, degree of connection of the lead to the supporter, charitable organizations with which the lead is associated, and the like), and donor outcomes 802 (e.g., whether the lead engaged with the campaign, whether the lead donated to the campaign, an amount that was donated by the lead, whether the lead responded to the email, whether the lead became a supporter, or the like). Each vector corresponds to a respective outcome and the attributes of the respective campaign and respective lead that led to the outcome. The machine learning system 702 takes in the vectors and generates a predictive donor prediction model 804 based on the vectors and the hyper-parameters. In embodiments, machine learning system 702 may store the donor prediction model 804 in the model datastore 308.

In embodiments, training of a donor prediction model can continue once the model is in use based on feedback received by machine learning system 702, which is also referred to as “reinforcement learning.” In embodiments, machine learning system 702 may receive a set of circumstances that led to a prediction (e.g., attributes of a lead that was predicted to donate to a campaign) and an outcome related to the campaign (e.g., whether the person donated to the campaign), and may update the model according to the feedback.

Referring back to FIG. 7, in embodiments, artificial intelligence (AI) system 704 leverages the predictive models to make predictions regarding leads with respect to campaigns. Examples of predictions include a likelihood that a lead is likely to engage with a campaign (e.g., donate to the campaign or volunteer for the campaign), an amount a lead is likely to donate to the campaign, a likelihood that a lead will respond to an email regarding the campaign, a likelihood that a lead will become a supporter, and the like. In embodiments, AI system 704 receives an individual identifier of a lead and a campaign identifier. The predictions made by a respective prediction model depend on the types of outcomes that were used to train the data. In response to the lead identifier and campaign identifier, AI system 704 may retrieve individual attributes 506 corresponding to the lead. In some embodiments, AI system 704 may obtain the individual attributes from a social graph and/or an individual record of the lead. Examples of additional attributes that can be used to make predictions about a lead include: affinity information, interests, personal history (such as educational history, employment history), indications of interest in particular topics, causes, individuals or groups (such as indicated by content contained on social network profiles, by emails sent by prospective donors, by tweets and posts of the prospective donor, and the like), donation history (including information tracked within the platform and information provided to the platform host by the supported organization), a capacity to give (which may be based on the past history of the donor), financial information about the donor (such as may be understood by one or more external systems), and the like. The AI system 704 may, for a lead, generate an individual profile (e.g., a feature vector) based on the individual attributes of the individual and may feed the individual profile to a prediction model corresponding to the campaign. In embodiments, the prediction model may output a confidence score for a respective prediction, where the confidence score indicates a degree of confidence in the predicted outcome. For example, in using a prediction model used to determine a likelihood that a lead will donate to the campaign, the prediction model can output a confidence score for a “will donate” outcome and/or a confidence score for a “will not donate” outcome. In embodiments, the AI system 704 may predict a positive outcome (e.g., “will donate”, “will support”, “will open”), if the confidence score exceeds a threshold. Alternatively, the AI system 704 may output the confidence scores for a set of leads to a requesting system (e.g., the lead prioritization system 122).

In embodiments, the clustering system 706 clusters records based on attributes contained therein. The clustering system 706 may implement any suitable clustering algorithm. For example, when clustering individual records to identify a list of leads corresponding to a sponsor, the clustering system may implement k-nearest neighbors clustering, whereby the clustering system identifies k individual records that most closely relate to the attributes defined in the individual record of the sponsor. In another example, the clustering system 706 may implement k-means clustering, such that the clustering system 706 identifies k different clusters of individual records, whereby the clustering system 706 or another system (e.g., lead prioritization system 122) selects the leads from the cluster in which the individual record of the supporter is included.

In embodiments, the natural language processing system 708 generates text based on a template and one or more received attributes. In embodiments, the natural language processing system 708 may receive a template, campaign attributes, and person attributes of a donor and/or the supporter and may generate a personalized communication to the person regarding the campaign based on the template, campaign attributes, and person attributes. For example, the natural language processing system 708 may generate a message that indicates a nature of the relationship between the lead and the contact, a brief description of the campaign, a reason why the lead may be interested in the campaign, and an ask (e.g., a donation amount or a request for support). The natural language processing system 708 may implement any suitable natural processing techniques, such as end-to-end machine learning, or a series of stages including content determination, document structuring, aggregation, lexical choice, referring expression generation, and realization.

In embodiments, analytics system 710 performs analytics relating to various aspects of the campaign platform. In some embodiments, the analytics system 710, in combination with the natural language processing system 708, may monitor and analyze outcomes relating to certain communications sent by the platform 100 to individuals to determine which communication styles are most effective to engage leads (e.g., short v. long, with media or without, formal language or less formal language), what types of contacts make the best leads, which attributes are used to cluster individual records, which types of campaigns are the most effective, which communication mediums are the best for enlisting support (e.g., social networks v. text messages v. emails), and the like. In embodiments, the efficacy of personalized content may be tracked by the analytics system 710. Based on the response or action of a recipient (e.g., a potential donor) with respect to personalized content, the analytics system 710 may determine an outcome for each message. Example outcomes may include: “ignored,” “responded,” “responded negatively,” “enlisted in the campaign,” “became a supporter,” “donated to the campaign,” “volunteered,” “reached out to other leads” and the like. The outcome may be used by the natural language processing system 708 to improve text generation templates, messaging styles, messaging medium selection, and/or to update workflows associated with personalized content generation.

In embodiments, the analytics system 710 may generate one or more graphs, tables, or other visual indicia to indicate outcomes and other attributes of a campaign and/or leads identified for a particular campaign.

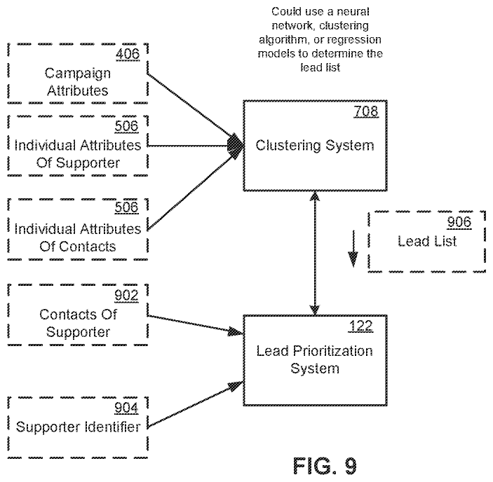

FIG. 9 illustrates a manner by which the lead prioritization system 122 obtains a prioritized lead list using the cognitive processes system 128 according to some embodiments of the present disclosure. In embodiments, the lead prioritization system 122 receives a list of contacts of a supporter and determines the lead list based thereon. The lead prioritization system 122 may provide the list of contacts 902 and a supporter identifier 904 to clustering system 706. It is noted that the lead prioritization system 122 may additionally or alternatively obtain individual records of individuals that may not be contacts of the supporter, but rather are individuals appearing in a social graph 600 that somehow relate to the supporter or the organization/campaign. For example, the lead prioritization system 122 may identify coworkers of a supporter, former classmates of a supporter, and/or individuals otherwise related to the individual from the social graph. In embodiments, the clustering system 706 may obtain individual profiles for the supporter and the contacts. The clustering system 706 clusters the profile of the supporter with the profiles of the contacts (and/or other relevant individuals) to identify one or more individual profiles of the contacts (and/or other relevant individuals) in the same cluster as the profile of the supporter, whereby the clustering system 706 may include the individual profiles of the individuals in the same cluster as the supporter in the lead list. In embodiments, the clustering system 706 returns a lead list 906. The lead list may indicate k individuals with the “closest” individual records to the individual record of the supporter, or a set of individuals whose individual records were clustered into the same cluster as the individual record of the supporter. In other embodiments, clustering system 706 returns the clusters of profiles, and lead prioritization system 122 prioritizes the individuals in the lead list 906 from the cluster to which the supporter belongs.

The foregoing techniques of FIG. 7 may be adapted for O2L campaigns. In some of these embodiments, the lead prioritization system 122 may obtain a set of contacts of an organization (e.g., from a CRM of the organization) and/or may identify individuals that relate to the campaign from the social graph 600 and may provide identifiers of the individuals to the clustering system 706. In embodiments, the clustering system 706 may cluster the individual profiles of the individuals with profiles of past donors to the campaign to identify the prioritized lead list.

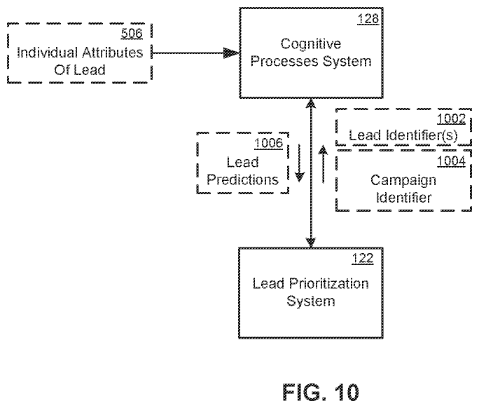

FIG. 10 illustrates an example of how the lead prioritization system 122 determines whether a lead identified in a list of leads is likely to contribute to a particular campaign using the cognitive processes system 128 according to some embodiments of the present disclosure. In embodiments, the lead prioritization system 122 provides lead identifiers 1002 of one or more respective leads and a campaign identifier 1004 to AI system 704. In embodiments, the AI system 704 may load a donor prediction model corresponding to the campaign identifier 1004 of the particular campaign. The AI system 704, for each lead indicated by the one or more lead identifiers 1002, may obtain the individual attributes 506 of the lead based on the lead identifier. For each lead, the AI system 704 may feed the individual attributes of the lead to the donor prediction model. In embodiments, the donor prediction model outputs a confidence score associated with a possible outcome (e.g., a score indicating a degree of likelihood that the lead will contribute to the campaign). In response to the confidence score of a lead, the AI system 704 may determine whether the donor is likely to contribute to the campaign (e.g., by comparing the confidence score to a threshold). The AI system 704 may output the prediction to the lead prioritization system. The lead prioritization system 122 may iterate in this manner for each lead in the lead list.

In embodiments, lead prioritization system 122 provides the supporter, for each lead in the lead list, solicitation information that indicates one or more reasons why a lead may be willing to donate. For example, the lead prioritization system 122 may output a reason indicating that the lead is also a graduate of the supported institution and the profile page of the lead on LinkedIn indicates an interest in physics, where the campaign is for a new science building for a university. In some of these embodiments, lead prioritization system 122 may leverage analytics system 712 to determine the reason or reasons a lead was selected. In embodiments, lead prioritization system 122 may undertake prediction and suggest leads based on analysis of multiple supporters, such as to manage an appropriate level of contacts for a given donor (e.g., to avoid having a lead who has many contacts among the supporters of a campaign receive too many contacts).

The lead prioritization system 122 may output the list of leads (e.g., contacts) and a prediction and/or an indicator of the likelihood of donation/engagement to the supporter via the user device 108 of the supporter (e.g., web base interface, email, native application, and the like). The supporter may select a set of some number of leads that the supporter is willing to contact. It is noted that in O2L embodiments, the lead prioritization system 122 may output the list of leads and predictions relating thereto to a user affiliated with the organization, who then may solicit donations from leads that are determined likely to donate to a campaign.

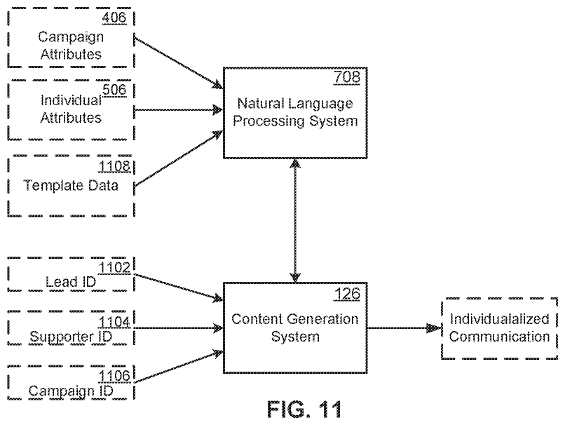

FIG. 11 illustrates a manner by which the content generation system 126 may generate personalized content using the cognitive processes system 128 according to some embodiments of the present disclosure. In embodiments, the content generation system 126 receives a lead identifier 1102, a supporter identifier 1104, and a campaign identifier 1106. In embodiments, the content generation system 126 may determine an appropriate template to use based on the relationship of the donor and the supporter and/or based on other considerations (e.g., donor is more likely to respond to less formal messages or more formal messages). In some embodiments, the content generation system 126 may obtain one or more prompts that indicate the relationship of the donor to the campaign and/or the supporter. In embodiments, the content generation system 126 may select one or more text generation templates based on the prompts. In embodiments, the content generation system 126 may provide the text generation template (or an identifier thereof) to the natural language processing system 708, along with the lead identifier 1102, the supporter identifier 1104, and the campaign identifier 1106. In embodiments, the natural language processing system 708 may obtain campaign attributes 406 based on the campaign identifier 1106, and individual attributes 506 corresponding to the donor based on the lead identifier 1102, and (in P2P embodiments) individual attributes 506 corresponding to the supporter based on the supporter identifier 1104. The natural language processing system 708 may then generate the personalized content based on the selected template, the campaign parameters, and/or the individual attributes of the donor and/or the supporter. In embodiments, the natural language processing system 708 may output the generated content to content generation system 126.

In embodiments, a supporter or an individual associated with the organization may approve the generated content provided by content generation system 126 and/or make edits to the generated content, then send the content via email or other channels (e.g., social networking posts, direct messages, text message, and the like). In embodiments, the campaign platform 100 tracks the solicitation event. In embodiments, the campaign platform 100 may track the solicitation event and outcomes relating thereto. In embodiments, the platform 100 may track the solicitation event so as to credit a supporter for making the contact if the prospective donor engages with the campaign. In embodiments, the platform 100 may track the solicitation event so as to credit a supporter for making the contact if the prospective donor engages with the campaign. In embodiments, the platform 100 may track the solicitation event for reinforcing one or more donor prediction models.

Referring back to FIG. 3, in embodiments, the workflow system 130 supports various workflows associated with a campaign, including initial contacts, follow ups, donor outcomes, thank you notes, and the like. In embodiments, the workflow system 130 may support various workflows associated with a campaign, such as including interfaces of the platform by which a user may review various analytic results, status information, and the like. For example, the workflow system 130 may display a status chart that displays when various messages were sent to respective leads, whether the respective leads responded and/or supported the campaign, and/or when to transmit a subsequent message to the respective leads. In embodiments, the workflow system 130 tracks the operation of a post-donation follow-up module to ensure that the correct follow-up messages are automatically, or under control of a campaign agent (e.g., a supporter) using the campaign platform 100, sent to the correct leads at the correct times to maximize their enthusiasm for the cause and willingness to donate when called upon. In operation, the workflow system 130 may create a workflow for each lead. Each workflow may include a timeline and workflow logic that defines when certain actions are to be taken with respect to the particular lead to which the workflow corresponds. The actions may include “send an initial message,” “send follow up message,” “send thank you message,” “remove from lead list,” and the like. The logic may define which actions are to be taken with respect to a timeline and in response to specific outcomes. For example, the logic may define a follow up message should be sent in response to an outcome that indicates no follow up was received from the lead in the previous five days. In another example, the logic may define a thank you message should be sent in response to an outcome that indicates that the lead has indicated that he or she will support the campaign. In response to an outcome with respect to a lead, the workflow system 130 may update the workflow associated with the lead. The workflow system 130 may present the updated workflow to the supporter to which the lead corresponds.

FIG. 12 illustrates an example method 1200 for training a machine-learned donor prediction model (or “donor prediction model) on behalf of an organization. In these embodiments, the donor prediction model may be used to determine whether an individual is likely to donate to a campaign of the organization. As discussed, the donor prediction model may be trained in part using historical donor data of the organization. The donor prediction model may be any suitable type of model (e.g., a decision tree, a random forest, a regression-based model, any suitable type of neural network, a Hidden Markov model, or the like). In some of these embodiments, the donor prediction model is a look alike model. In embodiments, the method 1200 may be executed by a processing system of the platform 100 in response to a new campaign being initiated on the platform 100 by an organization.

At 1210, the platform 100 creates a campaign on behalf of an organization. In embodiments, a user affiliated with the organization requests the creation of the new campaign via a GUI provided by the platform 100. In creating the campaign, the user may upload information relating to the campaign and/or the organization. For instance, a user may provide a name of the organization, a tax id of the organization, a physical address of the organization, contact information for the organization, a web address of the organization's website, a logo of the organization, a name of the campaign, a description of the campaign, the goals of the campaign, a start and/or end date of the campaign, a geographic region of interest of the campaign, a web address of a webpage of the campaign, and/or the like. In response to the user request and the provided information, the platform 100 may generate a new campaign. In doing so, the platform 100 may generate a new campaign record that includes a set of campaign attributes. The campaign attributes may be obtained from the user provided information, and in some embodiments, from additional data sources.

At 1212, the platform 100 receives historical donor data of an organization. In embodiments, the user affiliated with the organization may upload historical donor data of the organization or may link the platform 100 to a data source that includes the historical donor data of the organization. For example, the user may upload a spreadsheet containing the historical donor data or may link a CRM account of the organization to the platform 100. The historical donor data may indicate names and/or unique identifiers (e.g., email address and/or mobile phone number) of the past donors. The historical donor data may further include instances where the donor donated to a campaign of the organization, an amount of the donation (e.g., monetary amount or time amount), dates of donations, and the like. In some cases, the historical donor data of an organization may include richer data, such as a job title of the donor, an employer of the donor, an address of the donor, an income level of the donor, and/or the like.

At 1214, the platform 100 identifies individuals indicated in the historical donor data. In embodiments, the platform 100 may parse the historical donor data to identify unique identifiers (email address and/or mobile number) and/or semi-unique identifiers (e.g., name, city/state, employer, and the like).

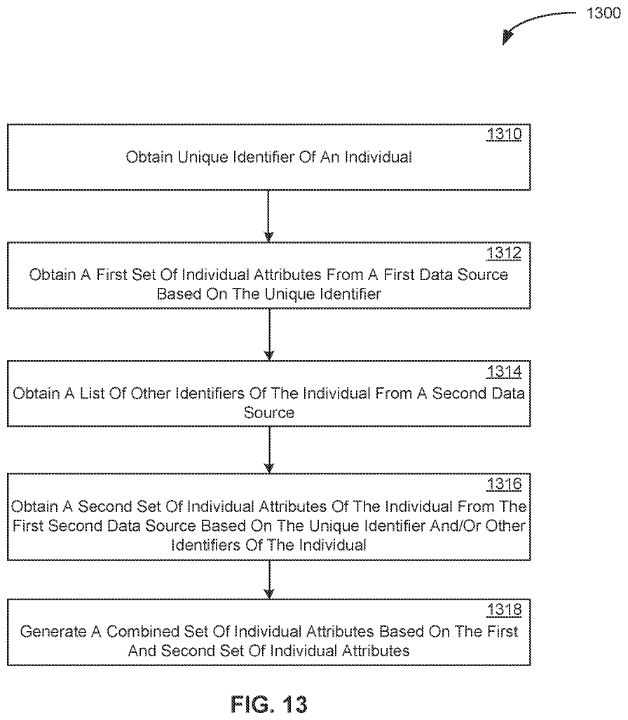

At 1216, the platform 100 resolves the identities of the individuals indicated in the historical donor data. In resolving the identities of individuals indicated in the historical donor data, the platform 100 may, for each individual, identify a set of attributes of an individual that may be associated with different identities of the individual (e.g., different email addresses, a mobile number, a combination of semi-unique identifiers, and/or the like). The platform 100 may resolve identities of an individual in any suitable manner. A non-limiting example of identity resolution is provided in FIG. 13. In embodiments, the result of the identity resolution process is a set of individual attributes that correspond to an individual that are obtained from one or more data sources using a set of identifiers (unique and/or semi-unique) of the individual.

In some embodiments, the platform 100 may generate an individual record that includes information relating to the individual in response to resolving the individual's identity, including the individual's name, contact information, an address of the individual, any other collected individual attributes of the individual, outcomes associated with the individual, and the like. In some of these embodiments, one or more data items in the individual record may be stored as references to protected organization data. For example, outcomes with respect to a particular campaign of an organization, information provided about the individual in the historical donor data of the organization, and/or other information provided by the organization relating to the individual may be represented by a reference to the protected organizational data of organization, such that the protected organizational data may only be used in tasks relating to the organization.

At 1218, the platform 100 generates individual profiles for each of the unique individuals based on the identity resolution process. In embodiments, the platform 100 may generate a profile that includes a set of individual attributes that are relevant to the training tasks. In embodiments, the individual profiles generated by the platform 100 for the training task may define a set of relevant attributes for training. In embodiments, the set of attributes may be selected by the developer, a data scientist, or via a machine-learning technique. For each individual, the platform 100 may obtain a set of individual attributes of the individual and may include those individual attributes in the individual profile of the individual. In some embodiments, the individual attributes of an individual are obtained from the individual record of the individual. To the extent that some of the attributes are references to protected organizational data of an organization, those individual attributes are only included in the individual profile if the training is being performed for the organization. Otherwise, those attributes are not accessible for the training task.

At 1220, the platform 100 generates training data based on the individual profiles. In embodiments, the training data may be a collection of training data pairs, whereby each pair includes an individual profile of an individual and an outcome relating to the individual. For example, if the model is being trained to determine whether someone is likely to contribute to a campaign, the outcomes of respective individuals may indicate whether the individual previously contributed to a campaign (e.g., another similar campaign of the organization or the current campaign). In another example, if the model is being trained to determine whether an individual is likely to support the campaign, the outcomes of the individuals may indicate whether the respective individuals opted to support the campaign. In another example, if the model is being trained to determine whether an individual is likely to respond to a solicitation (e.g., click a link to the organization's webpage), the outcomes of the individuals may indicate whether the respective individuals clicked on a link to the organization's webpage, read a solicitation email from the organization, or the like.

In some embodiments, most of the information provided by an organization relates to individuals that donated to the organization, or at least responded to solicitations initiated on behalf of the organization. Thus, in some embodiments, the platform 100 is configured to synthesize negative outcome data to train the model with. In these embodiments, the platform 100 may obtain individual attributes of random individuals (e.g., individuals listed in third party data sources) and may perform the identity resolution process on those individuals to obtain an enhanced set of individual attributes of the random individuals. The platform 100 may then generate an individual profile for each of these random individuals based on the enhanced set of individual attributes and may assign a negative outcome to the training data pair that includes the profile (e.g., did not contribute, did not support, did not respond, etc.). In embodiments, the platform 100 may determine a number of synthesized profiles (also referred to as “negative profiles”) to generate based on the number of individual profiles that were generated using positive outcomes (referred to as “positive outcome profiles”). For example, the platform 100 may maintain a ratio of positive outcome profiles to negative outcome profiles. For example, if one out of every ten individuals donate, then for everyone positive outcome profile, the platform may generate nine negative outcome profiles. The ratio of positive outcomes to negative outcomes may be set by a developer/data scientist, historical analytical data (e.g., ratio of positive outcomes v. negative outcomes), or randomly.

At 1222, the platform 100 trains a machine-learned prediction model based on the training data. The machine-learned prediction model may be any suitable type of model. In embodiments, the machine-learned prediction model is a look-alike model, whereby a look-alike model, for an input individual profile, identifies individuals whose profiles most closely resemble profiles of past donors (e.g., using prediction models, clustering, and/or classification models. In some embodiments, the machine-learned model is a random forest model that includes a set of decision tree models, whereby the output of the model is based on the outputs of each of the decision tree models. The machine-learned model may be any other suitable type of model, such as a regression-based model, any suitable type of neural network, a Hidden Markov model, or the like. It is noted that random forest models, regression-based models, neural networks, decision trees, Hidden Markov Models, and the like may be look alike models.

In embodiments, the platform 100 trains the machine-learned model based on a segment of the training data (e.g., 75% of the training data) to train the model. Depending on the type of prediction model being trained, the platform 100 will execute the training algorithm corresponding to the type of model being trained using the segment of the training data. The remainder of the training data (e.g., the remaining 25% of the training data) may be used to test the accuracy of the model. For instance, the profiles in the remaining segment of the training data may be input into the trained model, which outputs a prediction for each profile. The prediction is then compared to the outcome of the profile to determine whether the model accurately predicted the outcome. If the model is not sufficiently predicting outcomes (e.g., <90% accuracy), the platform 100 may retrain the model. If the model is sufficiently predicting outcomes (e.g., >90% accuracy), then the platform 100 may store the model in a model datastore, such that the model may be leveraged on behalf of the organization that created the campaign.

In some embodiments, the platform 100 trains different types of prediction models for a campaign using the same training data and different sets of hyper-parameters. For example, the platform 100 may train random forests, regression-based models, decision trees, neural networks, and/or other suitable types of models in the manner described above. The platform 100 may then test each model to determine which model is the most accurate for the given campaign. For example, in some scenarios a random forests model may predict likely contributors to a campaign the most accurately; while in other scenarios, a regression-based model may predict likely contributors more accurately. Upon determining the most accurate model, the platform 100 may store the most accurate model in a model datastore, such that the model may be leveraged on behalf of the organization that created the campaign.

At 1224, the platform 100 receives feedback relating to the one or more outcomes stemming from one or more predictions output by the machine-learned prediction model and reinforces the machine-learned prediction model based thereon. In some embodiments, the platform 100 receives feedback in response to solicitations of individuals determined to be potential donors by the machine-learned prediction model. For example, if a lead is determined to be a likely donor by the prediction model, the platform 100 may monitor whether the lead is converted into a donor within an allotted time period (e.g., one week). If the lead is converted into a donor in this example, the platform 100 may generate a training data pair that includes a donor profile (which is an individual profile) of the donor and a positive outcome. If the lead is not converted in this example, the platform 100 may generate a training data pair that includes a donor profile (which is an individual profile) of the donor and a negative outcome. The platform 100 may collect a batch of outcomes in this manner and may retrain the prediction model using the training data pairs resulting from the predictions made by the prediction model. The platform 100 may reinforce the model in this manner during the duration of the model's use.

It is noted that while the method 1200 is described with respect to training a donor prediction model, the method 1200 may be performed to train a prediction model that determines whether an individual is likely to sponsor a campaign.

FIG. 13 illustrates an example method 1300 for resolving an identity of an individual. The method 1300 may be executed by a processing system of the platform 100 to resolve an identity of an individual. For example, data relating to the individual may be linked to different email addresses, phone numbers, and/or other unique identifier or semi-unique identifiers (e.g., a combination of name, city, state, and employer). The method 1300 may resolve the identity of the individual so that a richer individual profile of the individual may be generated without having different profiles pointing to the same individual. The identity resolution process may be used when generating training data, identifying potential supporters or donors, or other applicable workflows.

At 1310, the platform 100 receives a unique identifier of an individual. In embodiments, the unique identifier may be an email address or a mobile phone number of an individual. The unique identifier may be obtained from any suitable source. In embodiments, the unique identifier may be found in the historical donor data of an organization. In embodiments, the unique identifier may be found in a contact provided by an employee of an organization, a supporter of a campaign of the organization, or any other user affiliated with the organization. In embodiments, the unique identifier may be provided by a CRM that is used by an organization in response to the CRM being linked to the platform 100 (e.g., via an API). The unique identifier may be obtained from other suitable sources as well.

At 1312, the platform 100 obtains a first set of individual attributes of the user from a first data source, including potentially semi-unique identifiers of the individual. In embodiments, the first data source is an attribute-based data collection that includes individual data of a large number of individuals, which may include duplicative entries for respective individuals. The attribute data collection may be proprietary (e.g., collected by the platform 100) and/or may be purchased/licensed from a third party (e.g., Full Contact™). In the latter scenario, the attribute-based data collection may be downloaded from the third party and stored by the platform 100 or may be accessed from the third party via an API. In embodiments, the attribute-based data collection may be collected by crawling or otherwise collecting the data from different data sources (e.g., websites, news articles, social media, government filings, and the like). As such, the first attribute data collection may include vast amounts of data relating to thousands, millions, or billions of individuals; there may be, however, multiple entries in the attribute data collection that correspond to a respective user. For example, an individual may have different email accounts that were used to sign up for different services (e.g., a personal email account used to create a Facebook® profile and a work email account used to create a LinkedIn®). Furthermore, as the individual changes jobs, the individual may appear in different company websites (e.g., org charts) and may be identified on the website using a name, phone number, and location (e.g., office location or state/country). As such, data relating to the individual may be scattered throughout the first attribute data collection.

In embodiments, the platform 100 may query/search the first data source using the unique identifier of the individual. In response, the platform 100 obtains a first set of individual attributes that correspond to the unique identifier of the individual. However, as discussed, the obtained individual attributes are only those individual attributes that were previously linked with the unique identifier of the individual and the first data source may include additional attributes of an individual that are not linked to the individual.

At 1314, the platform 100 obtains a set of other identifiers of the individual from a second data source based on the unique identifier. In embodiments, the second data source is a contact-based data collection that stores related unique identifiers (e.g., email addresses, mobile phone numbers) of individuals. For example, if an individual has six known different email addresses, the contact-based data collection may link the six email addresses of the individual. In embodiments, the contact-based data source may further store attributes of individuals that may be used to probabilistically identify the user. For example, the contact-based data source may store one or more of names, addresses, locations (e.g., city/state combination), and/or other suitable attributes that may correspond to respective individuals.

In embodiments, the contact-based data source may be a cloud-based service, whereby the platform 100 accesses the contact-based data source via an API of the second data source. In these embodiments, the platform 100 may transmit an API request to the contact-based data source that indicates the unique identifier of the individual. In response, the contact-based data source may return any other unique identifiers that are linked to the unique identifier indicated in the API request. In some embodiments, the contact-based data source may further return additional attributes that are linked to the unique identifier, such as a name, an address, and/or a location of the individual.

At 1316, the platform 100 obtains a second set of individual attributes of the user from the first data source (e.g., an attributed-based data source) based on the other unique identifiers and/or semi-unique identifiers. In embodiments, the platform 100 may query/search the attribute-based data source with each of the unique identifiers obtained from the second data source to obtain a second set of individual attributes. Furthermore, in some embodiments, the platform 100 may identify additional individual attributes of the individual using a probabilistic approach. In these embodiments, the platform 100 may query/search the second data set using one or more combinations of the individual's attributes that are likely to uniquely identify the individual. For example, combinations such as [name, age, and location], [name, age, and employer], [name, age, and alma matter], [name, location, and employer], [name, age, employer, and location], or the like may be used to search the first data source, such that entries that match each of the individual attributes in the combination may be probabilistically determined to relate to the individual. In these embodiments, the probabilistically determined attributes may be included in the second set of individual attributes. Furthermore, in some embodiments the platform 100 may query additional attribute-based data sources using the unique and/or semi-unique identifiers of the individual to further enrich the second set of individual attributes.

At 1318, the platform 100 generates a combined set of individual attributes based on the first set of individual attributes and the second set of individual attributes. In some embodiments, the platform 100 may dedupe and combine the first set and second set of individual attributes to obtain the combined set of individual attributes of the individual. The combined set of individual attributes may be used in a number of different applications. For example, the combined set of individual attributes may be combined with a donation outcome (e.g., positive outcome or negative outcome) to generate a training data pair (e.g., [attributes, outcome]) relating to the individual that may be included in the training data that is used to train a prediction model (e.g., a donor prediction mode). In another example, the combined set of individual attributes may be used to generate an individual profile (or “lead profile”) of a lead, whereby the individual profile is fed into a prediction model to determine whether the individual is likely to contribute and/or support a campaign.

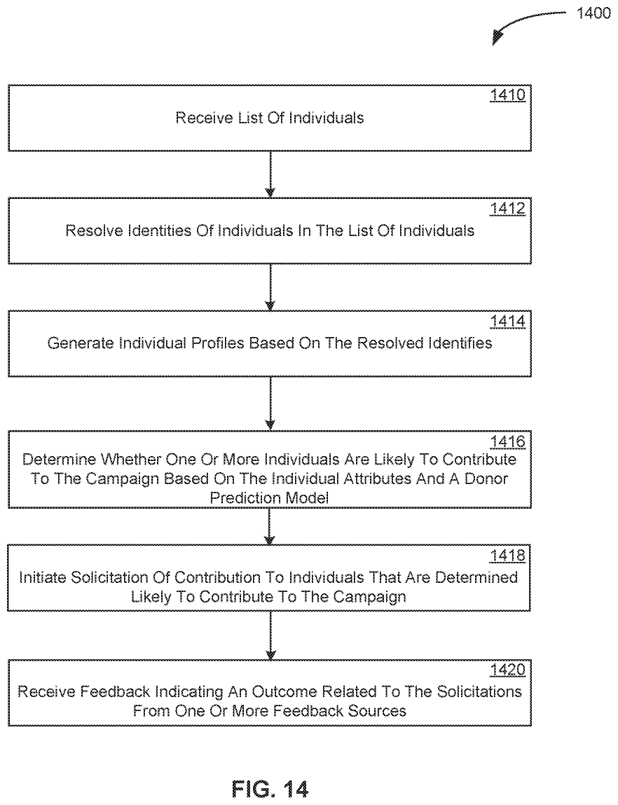

FIG. 14 illustrates an example method 1400 for identifying potential contributors to a campaign of an organization. In embodiments, a contributor to a campaign may be a potential donor (e.g., monetary or time-based donor). The method 1400 may be executed with respect to O2L campaigns and P2P campaigns.

At 1410, the platform 100 receives a list of one or more individuals. In embodiments, the list of individuals may be the contacts of a supporter or the organization. Additionally or alternatively, the list of individuals may be obtained from a third-party data source. Typically, the list may include, for each individual, a name of the individual and one or more unique identifiers (e.g., email address(es) and/or mobile phone number(s) of the individual.

At 1412, the platform 100 resolves the identities of the individuals in the list of individuals based on the unique identifiers associated with each individual indicated in the list of individuals. In embodiments, the platform 100 may perform an identity resolution process to identity an enriched set of individual attributes of the individual using one or more data collections. Non-limiting examples of identity resolution processes are provided throughout the disclosure (e.g., method 1300 of FIG. 13). The enriched set of individual attributes may indicate, for example, an age of the individual, a gender of the individual, a geographic region of the individual, a city state, and/or country of the individual, an address of the individual, an education level of the individual, alma maters of the individual, a degree of the individual, a job title of the individual, an employer and/or past employers of the individual, interests of the individual, social media “likes” of an individual, political affiliations and/or leanings of the individual, an income level of the individual, a net worth of the individual, a donation history of the individual, and/or any other suitable attributes.

At 1414, the platform 100 generates an individual profile (also referred to as a “lead profile” or “contact profile”) based on the set of attributes. In embodiments, the individual profile may structure data relating to the individual into an individual profile. For example, the individual profile may include the name of the individual, the unique identifier(s) of the contact, contact information of the individual (which may be one or more of the unique identifiers), and/or the individual attributes of the individual. In some embodiments, the platform 100 may generate and/or store an individual record of the individual based on the individual profile thereof. In some of these embodiments, the individual record may include data relating to the individual that was derived, inferred, or otherwise obtained by the platform 100 and may further include references to protected organization data of one or more organizations (e.g., a donation history of the individual with respect to one or more campaigns of the organization, outcomes of the individual when solicited for contributions, and/or other data provided by the organization). In these embodiments, the platform 100 may only use protected organization data relating to an individual only when performing tasks on behalf of the organization. For example, an individual's donation history with respect to an organization and/or any other data uploaded by the organization relating to the individual may only be used features to predict whether the individual is likely to contribute to campaigns of the organization. In this example, any individual data that was obtained from third party resources and/or determined by the platform 100 (e.g., via analytics and/or inference) may be used in tasks for any of the organizations on the platform 100.

At 1416, the platform 100 determines whether the one or more of the individuals are likely to contribute to the campaign based on the individual attributes of the individual and a machine-learned donor prediction model. In embodiments, the donor prediction model is trained specifically for the campaign. Thus, campaigns of different organizations leverage different donor prediction models. The platform 100 may retrieve the donor prediction model that is trained for the campaign (e.g., from a model datastore). For each individual, the platform 100 may generate a feature vector that includes one or more individual attributes of the individual. The platform 100 may feed a feature vector to the donor prediction model. The donor prediction model may then determine a confidence score that indicates a degree of confidence that the individual will contribute to the campaign. The confidence score may be compared to a threshold. If the confidence score corresponding to a feature vector of an individual exceeds the threshold, the platform 100 may determine that the individual is likely to contribute to the campaign. In some embodiments, the threshold is set based on a preference of the organization, such that higher thresholds may result in less false-positives but may result in individuals that would have donated not being solicited for donations. Conversely, lower thresholds may result in a larger group of potential donors, but with more false positives. In some embodiments, the threshold is learned via analytics (e.g., monitoring outcomes and adjusting the threshold to minimize false positives and/or false negatives). In other embodiments, the threshold is a static value that is set by the developers of the platform 100 or by a user affiliated with a campaign (e.g., a campaign manager).

At 1418, the platform 100 initiates solicitation of a contribution from the individuals that are determined likely to donate to the campaign. In embodiments, the platform 100 may determine solicitation information that indicates prompts and/or recommendations for soliciting the contribution. The platform 100 may determine the prompts by identifying relationships between the individual features of the individual and the campaign features and/or the individual features of a supporter of the campaign. In embodiments, the relationships between a lead and a campaign or a supporter may be determined from a social graph by identifying edges in the social graph that connect the lead to the campaign or supporter in a positive manner. Additionally or alternatively, the relationships may be determined by the donor prediction model, whereby the donor prediction model outputs the individual features of the lead that had the greatest impact on determining that the lead is likely to donate to the campaign.

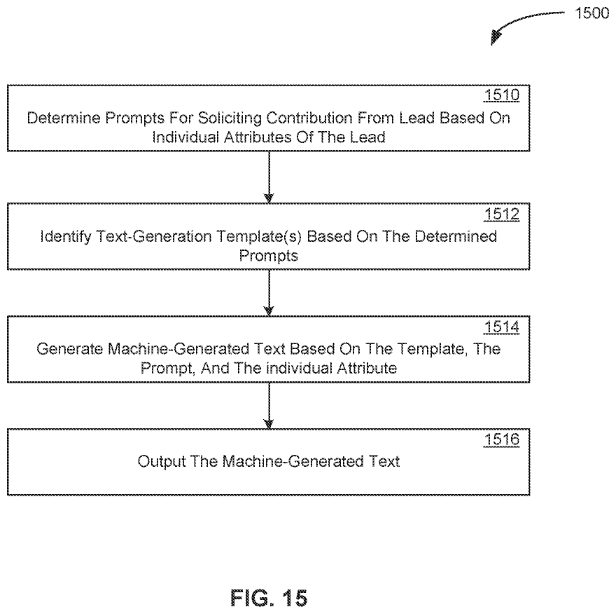

As previously discussed, the solicitation of a contribution may be automated and/or may be performed by a supporter of the campaign or by an employee or volunteer of the organization. In the former scenario, the platform 100 may generate machine-generated text using the individual profile of an individual and the campaign attributes as context. For example, the platform 100 may determine solicitation information relating to the individual based on the individual profile of the individual and the campaign attributes, whereby the platform may generate machine-generated text based on the solicitation information and one or more text generation templates. Examples of automated text generation are provided throughout the disclosure (e.g., FIG. 15). In the latter scenario, a user (e.g., a supporter or an employee/volunteer of the organization) may be presented with solicitation information relation to the lead via a GUI of the platform 100. The user may use this solicitation information to draft an electronic message (e.g., an email or text message) or during a conversation (e.g., phone call or text-based chat) with the lead to improve the likelihood that the lead contributes to the campaign.

At 1420, the platform 100 receives feedback from one or more feedback sources indicating an outcome relating to the solicitations of contributions. For example, the platform 100 may track whether a lead opened an email, clicked a link in the email, visited the organization's website, contributed to the campaign (and if so, what was the contribution), and/or other outcomes. The tracked outcome(s) relating to the solicitation from a lead may be combined with the features of the individual to generate a training data pair that is used to reinforce the donor prediction model that predicted that the lead was likely to contribute to the campaign. Furthermore, in some embodiments where the platform 100 generated text to solicit the contribution, the platform 100 may track the effectiveness of the text generation template(s) (used to generate the text) to determine which templates should be used with which type of individuals.

The foregoing method 1400 may be performed to identify potential supporters of a campaign, such as in a P2P campaign. In these embodiments, the prediction model may be trained to identify potential supporters of the campaign based on individual attributes and the campaign attributes.

FIG. 15 illustrates an example method 1500 for generating machine-generated text that is used to solicit a contribution from a potential donor. The machine-generated text may be, for example, an email subject line or a message body. In embodiments, the machine-generated text uses prompts relating to the potential donor to generate personalized content for the recipient.

At 1510, the platform 100 determines one or more prompts to solicit a contribution from a potential donor. In embodiments, the platform 100 may determine one or more prompts relating to the potential donor based on one or more attributes of the potential donor and one or more attributes of the campaign. In some embodiments, the platform 100 may determine one or more relationships between the potential donor and the campaign. In some of these embodiments, the platform 100 may utilize a social graph (e.g., FIG. 6) to determine relationships between the potential donor and the campaign. In some embodiments, the platform 100 may determine whether the relationship is likely positive (e.g., graduated from a particular department of a university for which the campaign is raising money) or likely negative (e.g., attended but not graduate from a university for which for which the campaign is raising money). If a relationship is likely a positive relationship, then the platform 100 uses the relationship as a prompt. In embodiments where the machine-generated text is being generated to aid a supporter in soliciting a donation, the platform 100 may determine the one or more prompts based on the individual attributes of the potential donor, the attributes of the supporters, and/or the attributes of the campaign. The platform 100 may determine positive relationships between the potential donor and the supporter, the potential donor and the campaign, and/or the potential donor, the supporter, and the campaign. In some embodiments, the platform 100 may score each relationship to determine the strongest relationships using a scoring model. In these embodiments, the platform 100 may determine the prompts based on the N (e.g., one or two) strongest relationships as the prompts.

At 1512, the platform 100 identifies one or more text-based templates to use for text generation based on the one or more prompts. In embodiments, the platform 100 may retrieve text-based templates based on the prompts. In some of these embodiments, each text-based template may be tagged by attribute type and/or prompt type. In these embodiments, the platform 100 may retrieve text-based templates on the prompt types of the N prompts and/or the underlying attribute types of the prompts.

At 1514, the platform 100 may generate the machine-generated text based on the text-based template and the individual attributes of the potential donor. In embodiments, the platform 100 may utilize a natural processing system to generate the text. In these embodiments, the platform 100 may feed the text-based text and the attributes of the potential donor to the natural processing system, which forms natural language based thereon.

At 1516, the platform 100 outputs the machine-generated text. In embodiments, the machine-generated text is output into an electronic message that is automatically sent to the lead. In some embodiments, the machine-generated text is input into an electronic message that is presented to a human (e.g., a supporter or an employee of the organization) that may review and/or edit the text before sending. The machine-generated text may be output to other suitable mediums without departing from the scope of the disclosure.

While only a few embodiments of the present disclosure have been shown and described, it will be obvious to those skilled in the art that many changes and modifications may be made thereunto without departing from the spirit and scope of the present disclosure as described in the following claims. All patent applications and patents, both foreign and domestic, and all other publications referenced herein are incorporated herein in their entireties to the full extent permitted by law.

The methods and systems described herein may be deployed in part or in whole through a machine that executes computer software, program codes, and/or instructions on a processor. The present disclosure may be implemented as a method on the machine, as a system or apparatus as part of or in relation to the machine, or as a computer program product embodied in a computer readable medium executing on one or more of the machines. In embodiments, the processor may be part of a server, cloud server, client, network infrastructure, mobile computing platform, stationary computing platform, or other computing platform. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through a machine that executes computer software on a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions. Computer software may employ virtualization, virtual machines, containers, docker facilities, portainers, and other capabilities.

Thus, in one aspect, methods described above and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A computer-implemented method comprising:
creating, by one or more processors of a computing system, a campaign on behalf of an organization;
receiving, by the one or more processors, organizational data from the organization, the organizational data including donor outcome data indicating a plurality of donors that have contributed to one or more campaigns of the organization in the past and, for each donor of the plurality of donors, a respective set of donor attributes of the donor;
determining, by the one or more processors, random individual data of a plurality of random individuals, the random individual data indicating respective sets of individual attributes for a plurality of random individuals;
generating, by the one or more processors, training data based on the donor outcome data and the random individual data;
training, by the one or more processors, a machine-learned donor prediction model based on the training data, wherein the donor prediction model is trained to receive a set of attributes of an individual and determine a likelihood that the individual will donate to the campaign based on the set of attributes of the individual; and
leveraging, by the one or more processors, the machine-learned donor prediction model to determine whether a lead of the campaign is likely to contribute to the campaign based on one or more lead attributes of the lead donor.

2. The method of claim 1, wherein generating the training data includes:
obtaining additional donor attributes from one or more alternative data sources, the additional attributes including attribute types not initially included in the donor outcome data; and
supplementing the donor outcome data with the additional donor attributes to obtain supplemented donor data.

3. The method of claim 2, wherein the supplemental donor data and the random person data define the same types of attributes.

4. The method of claim 2, wherein obtaining the additional donor attributes includes, for each donor in the plurality of donors:
querying a first alternative data source using a unique identifier associated with the donor to obtain other unique identifiers associated with the donor; and
querying a second alternative data source using the unique identifier and the other unique identifiers associated with the donor to obtain the additional donor attributes.

5. The method of claim 4, wherein the unique identifier of a donor is an email address of the donor or a phone number of the donor.

6. The method of claim 4, wherein obtaining the additional donor attributes further includes:
for each donor, querying, by the one or more processors, the first alternative data source with two or more non-unique attributes of the donor to determine additional unique identifiers associated with the lead; and
in response to determining that the respective donor is associated with one or more other unique identifiers, querying, by the one or more processors, the second alternative data source with the one or more additional unique identifiers to obtain at least a portion of the additional donor attributes.

7. The method of claim 6, wherein the non-unique attributes are obtained from the organizational data of the organization.

8. The method of claim 1, wherein the machine-learned donor prediction model is a look-alike model.

9. The method of claim 8, wherein the look-alike model is a random forest model that includes a plurality of decision trees.

10. The method of claim 1, wherein generating the training data includes:
positive outcome data based on the donor outcome data; and
generating negative outcome data based on the random individual data.

11. The method of claim 10, wherein generating the negative outcome data includes:
for each random individual of one or more random individuals indicated in the random individual data, assigning a negative donation outcome to the set of individual attributes of the random individual.

12. The method of claim 11, wherein the negative donation outcome corresponding to a respective random individual indicates that the respective random individual did not contribute to the one or more campaigns.

13. The method of claim 11, wherein the random individual attributes of the random individuals are obtained from one or more third-party data sources that provide attributes of a collection of different individuals.

14. The method of claim 13, wherein determining the random individual data of the plurality of random individuals includes determining a number of random individuals to include in the plurality of random individuals based on a number of past donors in the plurality of donors indicated in the donor outcome data of the organization.

15. The method of claim 14, wherein the number of random individuals is set such that a ratio of the number of random individuals to the number of past donors is equal to a predetermined ratio.

16. The method of claim 1, wherein the machine-learned donor prediction model is trained specifically for the campaign.

17. The method of claim 16, wherein the historical donor data of the organization is used only in association with the organization.

18. A computer-implemented method comprising:
creating, by one or more processors of a computing system, a digital campaign on behalf of an organization;
receiving, by the one or more processors, organizational data from the organization, the organizational data being comprised of one or more electronic files and including donor outcome data indicating a plurality of donors that have contributed to one or more campaigns of the organization in the past and, for each donor of the plurality of donors, a respective set of donor attributes of the donor;
obtaining, by the one or more processors, random individual data of a plurality of random individuals from one or more third-party data sources that provide attributes of a collection of different individuals, the random individual data indicating respective sets of individual attributes for a plurality of random individuals;
generating, by the one or more processors, training data based on the donor outcome data and the random individual data, including:
generating positive outcome data based on the donor outcome data; and
generating negative outcome data based on the random individual data by, for each random individual of one or more random individuals indicated in the random individual data, assigning a negative donation outcome to the set of individual attributes of the random individual;
training, by the one or more processors, a machine-learned donor prediction model based on the training data, wherein the donor prediction model is trained to receive a set of attributes of an individual and determine a likelihood that the individual will donate to the campaign based on the set of attributes of the individual; and
leveraging, by the one or more processors, the machine-learned donor prediction model to determine whether a lead of the campaign is likely to contribute to the campaign based on one or more lead attributes of the lead donor.

19. The method of claim 18, wherein determining the random individual data of the plurality of random individuals includes determining a number of random individuals to include in the plurality of random individuals based on a number of past donors in the plurality of donors indicated in the donor outcome data of the organization such that a ratio of the number of random individuals to the number of past donors is equal to a predetermined ratio.

20. The method of claim 18, wherein the machine-learned donor prediction model is trained specifically for the campaign and the historical donor data of the organization is used only in association with the organization.
